(19) United States
(12) Patent Application Publication
(10) Pub. No.: US 2009/0096815 A1
(43) Pub. Date: Apr. 16, 2009

(54) IMAGE SIGNAL PROCESSING DEVICE AND COLOR CONVERSION PROCESSING METHOD

(75) Inventors: Hiroyuki Fukuda, Tokyo (JP); Yasuhiro Komiya, Tokyo (JP); Takuji Horie, Sagamihara-shi (JP); Akira Matsushita, Tokyo (JP); Takeyuki Ajito, Tokyo (JP); Ken Ioka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/244,163

(22) Filed: Oct. 2, 2008

(30) Foreign Application Priority Data
Oct. 10, 2007 (JP) 2007264792

(51) Int. Cl. G09G 5/10

(52) U.S. Cl. 345/690

(57) ABSTRACT

A color conversion processing execution portion 114 implements color conversion processing on an input image signal, and outputs a color conversion-processed display image signal to an image display unit. Color conversion characteristic information required for the color conversion processing performed by the color conversion processing execution portion 114 is gathered by a characteristic information gathering portion 106. A color conversion processing method selection portion 112 selects an optimum color conversion processing method from among a plurality of candidate color conversion processing methods that can be executed by the color conversion processing execution portion 114 on the basis of the input image signal and the input color conversion characteristic information. A display image signal caused as a result of the color conversion processing is output to a monitor display device 140.

### FIELD OF THE INVENTION

This invention relates to the processing and display of an image signal with enhanced color reproducibility, and more particularly to an image signal processing device which processes an image signal and outputs the processed image signal to a video display device in accordance with the type of the input image signal, the performance of the video display device that performs display on the basis of the image signal, and so on.

### DESCRIPTION OF THE RELATED ART

Image data obtained when an image is captured by an electronic imaging apparatus are input into a video display device as an image signal and displayed thereon. A solid state imaging element using a semiconductor such as a CCD or a C-MOS as an imaging device, an electron tube, or similar is used in the electronic imaging apparatus. These imaging devices have differing spectral sensitivity characteristics. Moreover, a dichroic prism, a dichroic mirror or an interference filter, or on-chip color filters provided directly on a light-receiving surface of the solid state imaging device, which are employed to obtain color image data by subjecting light from a field to be photographed to color separation, have different spectral transmission characteristics depending on the used materials and so on. In addition, the spectral transmission characteristic of an imaging lens, the level/gamma (bias/tone) characteristic of a signal processing system in the electronic imaging apparatus, and so on are all different, and therefore differences occur in the color reproducibility characteristic.

As regards the video display device, differences occur in the principle of display, the number of primary colors, the color (chromaticity) of the individual primary colors, and so on, and therefore, depending on the type of the video display device, differences occurs in the color reproducibility of the displayed image. Due to these differences among employed electronic imaging apparatuses and video display devices, it is known to be difficult to reproduce the colors of a photographed subject correctly.

Two methods are known as typical methods of reproducing the colors of a photographed subject. One is colorimetric color reproduction, and the other is red blue green (RGB) color reproduction. In colorimetric color reproduction, an XYZ colorimetric system, for example, is often used. This is a well known colorimetric system based on tristimulus values based on red green blue (RGB) light. When a wavelength of the light is represented by λ, color matching functions (CMF) of R, G, B are represented by x(λ), y(λ), z(λ), respectively, a spectrum of illumination light illuminating the photographed subject is represented by S(λ), a reflectance spectrum of the photographed subject is represented by R(λ), and a normalization constant is represented by K, the respective tristimulus values X, Y, Z of R, G, B can be determined through integration within a visible band (380 nm to 780 nm), as illustrated below.

X=K∫[R(λ)×x(λ)×S(λ)]dλ

Y=K∫[R(λ)×y(λ)×S(λ)]dλ

Z=K∫[R(λ)×z(λ)×S(λ)]dλ

As is evident from the above equation, the colors of the photographed subject represented by the above equation are determined by the spectral characteristic of the illumination light and the spectral reflectance of the photographed subject.

Chromaticity coordinate values are determined from the above tristimulus values using the following equation, for example, and the chromaticity coordinate values can be plotted on a chromaticity diagram.

x=X/(X+Y+Z)

y=Y/(X+Y+Z)

z=Z/(X+Y+Z)

The color range (gamut) that can actually be displayed cannot usually cover the gamut that can be defined by the XYZ colorimetric system due to the performance of the imaging apparatus, video display device, and so on. The gamut that can actually be displayed is expressed as “the color space of the device” or the like.

In RGB color reproduction, color reproduction through additive color mixture using the three primary colors of light is typically performed. An RGB signal is often used as an image signal output to a monitor device for a computer, which is one example of a video display device. The colors of each of the RGB primary colors that can be displayed by the monitor display device differ according to the maker, type and so on of the monitor display device. Therefore, colors reproduced in relation to an identical input signal may differ among monitor display devices. In other words, color reproduction is dependent on the device. Hence, to achieve accurate (device independent) color reproduction, it is necessary to determine a display color reference in relation to the input RGB input image signal. An example of a color space standard for realizing this is sRGB.

The video display device described above is based on three primary colors, and the gamut of the colors that can be reproduced by the video display device is represented by a triangular area formed by plotting the chromaticity points of the three primary colors on a CIE-xy chromaticity diagram and connecting the plotted chromaticity points with straight lines. A wide gamut video display device capable of inputting image signals that conform to Adobe RGB, in which the chroma saturation of the colors of the respective red, green and blue primary colors is greater than that of sRGB, has recently come into existence.

Furthermore, in recent years a technique has been developed to perform image pick-up using a multiband camera capable of performing color separation and image pick-up in a larger band number than three, for example six bands or sixteen bands, and displaying an image with a multiband image signal obtained as a result on a multiple primary color video display device having more than three, for example six, primary colors. With this technique, the characteristics of the multiple bands and multiple primary colors can be used to realize a wider gamut and reproduce the colors of a photographed subject spectroscopically. When the colors of the photographed subject are reproduced spectroscopically, the colors of the photographed subject can be dealt with using data such as the spectral reflectance, relative spectral radiance, and so on of the photographed subject. In a method employing the spectral reflectance data of the photographed subject, the colors of the photographed subject are dealt with according to spectral reflectance. CCM (computer color matching) performed in this method is known as isometric matching.

Incidentally, a problem referred to as observer metamerism is known. Observer metamerism occurs as a result of differences among people in the spectral sensitivity characteristic (luminosity) of the eye, and in recent years, this problem has come to attention in the field of color reproduction technology. When the spectral sensitivity of the eye of an observer observing a video display device differs from the standard spectral sensitivity of the eye and the observer observes an image displayed on a three-primary color video display device designed in consideration of the standard spectral sensitivity of the eye, the displayed colors may appear different to the intended colors (the colors assumed to be sensed by a standard observer). Variation and differences in the spectral sensitivity of the eye may occur according to race, and are also known to occur as a result of aging, lens disease, and so on. When an image is displayed using the multiband camera and multiple primary color video display device described above, it is possible to suppress apparent color differences caused by observer metamerism by matching data representing the relative spectral radiance of the photographed subject to the relative spectral radiance of the actual object using the aforementioned CCM technique. This technique may be referred to as “multiple primary color separation using a spectral approximation method”.

Multiple primary color separation using a spectral approximation method, with which observer metamerism can be suppressed as described above, is a technique employed to achieve color reproduction with maximum accuracy, and its use is expected to produce results in the medical field and so on. A natural vision format has been proposed as a method of reproducing the colors of a photographed subject using the reflectance or radiance of the photographed subject surface. In relation to this technique, http://www2.nict.go.jp/q/q262/3107/end102/NVHP(new)/document/NVF2 0.pdf is disclosed as “Natural Vision data file format specification Version 2.0s”. This disclosure also describes a method of deriving the reflectance of a photographed subject mathematically from a captured image signal. Further, JP2003-134351A discloses a technique of outputting a photographed signal obtained by capturing an image of a photographed subject using a multiband camera having a 16-band bandwidth to a multiple primary color display having six primary colors and displaying the image thereon. In this technique, an input profile of the multiband camera, an output profile of the multiple primary color display, and a color space conversion profile are used to convert the 16-band photographed signal into a 6-primary color display signal. The input profile and output profile include information indicating a correlation between the respective color signals and the spectra or spectral reflectance thereof. The color space profile includes at least one of the color matching function and an illumination light spectrum which illumination light spectrum is applied to the spectral reflectance to obtain a reflection spectrum.

### SUMMARY OF THE INVENTION

As described above, subject images displayed on a video display device include an image obtained through image pick-up using a multiband camera, an image created as a computer graphic, and an image obtained through image pick-up using a conventional RGB 3-band camera. Meanwhile, video display devices include a normal RGB monitor display device, a wide gamut RGB monitor display device, a monitor display device capable of inputting a colorimetric image signal, a monitor display device capable of inputting a multiband image signal and performing display in multiple primary colors, and so on. Hence, depending on the combination of the type of the input image signal and the type of the monitor display device, it is sometimes impossible to display an image in the correct colors. Further, it is sometimes impossible to display an image making full use of the color information included in the input image signal or the color reproduction capacity of the monitor display device.

To solve these problems, it is an object of this invention to provide a technique for obtaining an optimum display image corresponding to a combination of the type of an input image signal and the display capacity (color reproduction ability) of a video display device.

A first aspect of this invention is applied to an image signal processing device, and this image signal processing device solves the problems described above by comprising:

a color conversion processing portion for implementing color conversion processing on an input image signal and outputting a color conversion-processed display image signal to an image display unit;

a color conversion characteristic information input portion that inputs color conversion characteristic information required for the color conversion processing; and

a color conversion processing method selection portion that selects an optimum color conversion processing method, from among a plurality of candidate color conversion processing methods that can be executed by the color conversion processing portion, on the basis of the input image signal and the input color conversion characteristic information.

Another aspect of this invention is applied to a color conversion processing method for implementing color conversion processing on an input image signal and outputting a color conversion-processed display image signal to an image display unit, the color conversion processing method comprising:

inputting color conversion characteristic information used for the color conversion processing, the color conversion characteristic information including display characteristic information relating to the image display unit and image characteristic information included in the input image signal; and

selecting a color conversion processing method, which means selecting, in accordance with a predetermined order of precedence, a color conversion method having the highest order of precedence from among a plurality of applicable candidate color conversion methods on the basis of the input color conversion characteristic information.

### BRIEF DESCRIPTION OF THE DRAWINGS

For a more complete understanding of the present invention, the objects and advantages thereof, reference is now made to the following descriptions taken in connection with the accompanying drawings.

FIG. 1 is a block diagram illustrating the schematic constitution of a color conversion processing device according to an embodiment of this invention.

FIG. 2 is a block diagram illustrating the internal constitution of a color conversion processing execution unit.

FIG. 3 is a flowchart illustrating the main flow of a color conversion processing procedure executed by the color conversion processing device.

FIG. 4 is a flowchart illustrating a processing procedure accessed by the processing of the flowchart shown in FIG. 3 when an input is a spectral image signal and a monitor display device is a multiple primary color monitor display device.

FIG. 5 is a flowchart illustrating a processing procedure accessed by the processing of the flowchart shown in FIG. 3 when the input is a spectral image signal and the monitor display device is a colorimetric monitor display device.

FIG. 6 is a flowchart illustrating a processing procedure accessed by the processing of the flowchart shown in FIG. 3 when the input is a spectral image signal and the monitor display device is an RGB monitor display device.

FIG. 7 is a flowchart illustrating a processing procedure accessed by the processing of the flowchart shown in FIG. 3 when the input is a multiband colorimetric image signal and the monitor display device is a multiple primary color monitor display device.

FIG. 8 is a flowchart illustrating a processing procedure accessed by the processing of the flowchart shown in FIG. 3 when the input is a multiband colorimetric image signal and the monitor display device is a colorimetric monitor display device.

FIG. 9 is a flowchart illustrating a processing procedure accessed by the processing of the flowchart shown in FIG. 3 when the input is a multiband colorimetric image signal and the monitor display device is an RGB monitor display device.

FIG. 10 is a flowchart illustrating a processing procedure accessed by the processing of the flowchart shown in FIG. 3 when the input is a colorimetric image signal and the monitor display device is a multiple primary color monitor display device.

FIG. 11 is a flowchart illustrating a processing procedure accessed by the processing of the flowchart shown in FIG. 3 when the input is a colorimetric image signal and the monitor display device is a colorimetric monitor display device.

FIG. 12 is a flowchart illustrating a processing procedure accessed by the processing of the flowchart shown in FIG. 3 when the input is a colorimetric image signal and the monitor display device is an RGB monitor display device.

FIG. 13 is a flowchart illustrating a processing procedure accessed by the processing of the flowchart shown in FIG. 3 when the input is an RGB image signal.

FIG. 14A is a view illustrating an example of icons displayed on the monitor display device in accordance with the types of the input image signal and the connected monitor display device in a case where a spectral image signal is input into an RGB monitor display device.

FIG. 14B is a view illustrating an example of icons displayed on the monitor display device in accordance with the types of the input image signal and the connected monitor display device in a case where a spectral image signal is input into a multiple primary color monitor display device.

FIG. 15 is a flowchart illustrating a processing example in a case where the possibility of noise can be determined before the color conversion processing device performs the color conversion processing.

### DETAILED DESCRIPTION OF THE PREFERRED EMBODIMENTS

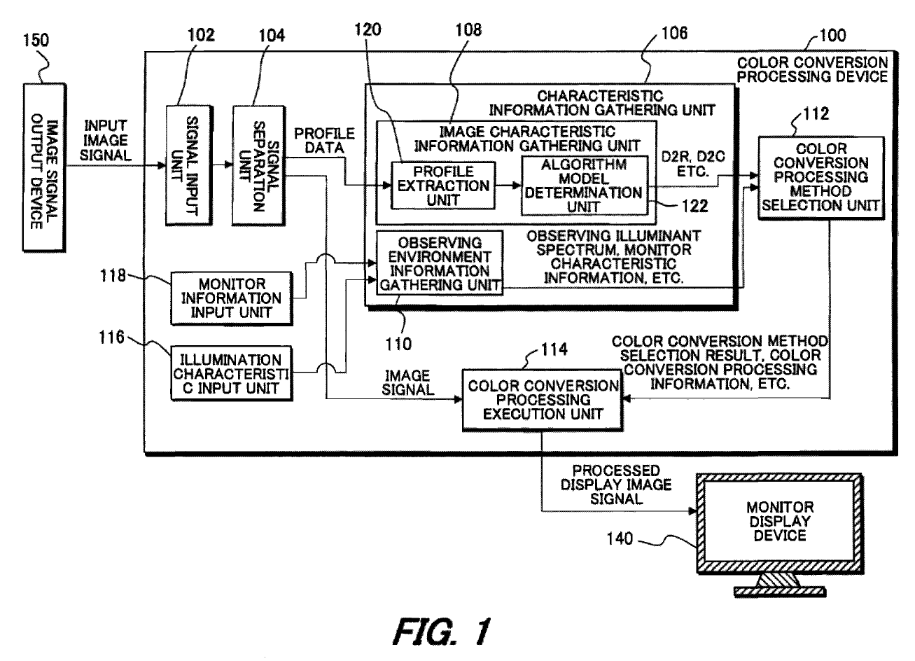

FIG. 1 is a block diagram showing the schematic constitution of a color conversion processing device 100 according to an embodiment of this invention. The color conversion processing device 100 may be implemented as a set top box connected between an image signal output device 150 and a monitor display device 140, for example. The image signal output device 150 may be a video camera, a video deck, a video recording/reproduction device, a television tuner including a BS broadcast tuner, a CATV adapter, a computer, and so on. Alternatively, the color conversion processing device 100 may receive image signals via a network such as the Internet. The color conversion processing device 100 receives and processes an input image signal from the image signal output device 150, and outputs a processed display image signal to the monitor display device 140.

In the embodiments of this invention, image display methods (display formats) selected on the basis of the types of image signals that can be input by the color conversion processing device 100, the types of monitor display device 140 that can be connected to the color conversion processing device 100, and the combination of the input image signal and the connected monitor display device 140, will be described with some examples.

1. Input Image Signal types

### (1-a) Spectral Image Signal

In a spectral image signal, an image input device profile and so on is added to a color image signal constituted by at least 4 bands, preferably 6 bands, or more than 6 bands. In this embodiment, the image input device is a camera, and therefore the profile of the camera used for image pick-up (the spectral sensitivity characteristic, tone characteristic, bias value, and so on of the camera), and information for determining the spectral reflectance of the photographed subject excluding the effect of the light that illuminates the photographed subject during image pick-up (hereafter, the light that illuminates the photographed subject during image pick-up will be referred to as the “input illuminant”) are added to the spectral image signal.

Hereafter, the information for determining the spectral reflectance of the photographed subject excluding the effect of the input illuminant will be referred to as “D2R information”. D2R indicates determining (estimating) the reflectance of a photographed subject from an input image signal (digital data), and stands for “Data to Reflectance”, i.e. “D to R”. D2R may be provided in the form of a matrix, and by applying a D2R matrix and so on to the spectral image signal, the spectral reflectance of the photographed subject can be estimated.

It should be noted that in the following description, a spectral image signal is assumed to be obtained through image pick-up using a multi-spectrum camera, but a spectral image signal may be output from other image input devices, for example a multi-spectrum scanner that performs image input by means of color separation in four or more spectra, for example. Further, a spectral image signal created using a CG (computer graphics) technique may be input into the color conversion processing device 100. In this case, the camera profile, the spectrum of the input illuminant, and statistical information regarding the photographed subject may be added as appropriate in accordance with the creative intentions of a CG image creator.

A spectral image signal occasionally includes D2S information instead of, or in addition to, D2R information. Similarly, to the D2R information, D2S information may be provided in the form of a matrix, and the relative spectral radiance of the photographed subject may be determined by applying the D2S matrix to the spectral image signal. D2S indicates determining (estimating) the relative spectral radiance of a photographed subject from an input image signal (digital data), and stands for “Data to Relative spectral radiance”, i.e. “D to S”. In the following description, it is assumed that the spectral image signal includes D2R information, but the spectral image signal may include D2S information instead of, or in addition to, the D2R information.

In an embodiment of this invention, image reproduction using a spectral image signal can be performed with a maximum gamut, and by employing a technique to be described below, an image that appears to be more natural and realistic to an observer can be obtained. Moreover, an image exhibiting less observer metamerism can be obtained through spectrum reproduction using a multiband image signal.

In the case of a spectral image signal, first, the aforementioned camera profile is applied to the spectral image signal, whereupon device dependence is removed from the spectral image signal. Then, using a technique known as “illumination conversion”, an image that appears to be natural and realistic to the observer (a person observing the displayed image) can be reproduced. Illumination conversion is a technique employed when displaying an image of a photographed subject on a monitor display device to perform color reproduction and display such that the photographed subject appears to be illuminated by the light illuminating the environment in which the monitor display device is disposed (hereafter, the light illuminating the environment in which the monitor display device is disposed will be referred to as the “observing illuminant”). By performing display in this manner, the photographed subject appears to the observer to exist in the observing environment, and therefore a more natural and realistic image can be observed.

In the illumination conversion technique, the aforementioned D2R information added to the spectral image signal is used to estimate the spectral reflectance of the photographed subject and a spectral reflectance image is generated. As is, the spectral reflectance image is not colored. In other words, when the surface of an object having a certain spectral reflectance is irradiated with light, a spectrum reflected as energy obtained by multiplying the spectral reflectance by the spectral distribution of the light is colored as light. Therefore, the spectral reflectance image cannot be seen. Hence, information relating to the spectrum of the observing illuminant is input into the color conversion processing device 100 and multiplied to the spectral reflectance image. This processing is known as “rendering”, and the observing illuminant applied in the rendering processing is known as a “rendering illuminant”. As a result of this illumination conversion processing, an image reproducing the photographed subject when illuminated by the observing illuminant, or in other words an image expressing the relative spectral radiance of the photographed subject, is generated. This illumination conversion technique is disclosed in “Heisei 16-nendo Natural Vision no Kenkyu Kaihatsu Project [Douga] (Jisedai Eizou Hyouji Densou System) Kenkyu Kaihatsu Houkokusyo” (2005 Research and Development Report on Natural Vision [Motion Picture] <Advanced Video Display/Transmission System>), issued on Mar. 31, 2005, National Institute of Information and Communications Technology, the disclosure of which is incorporated by reference. Hereafter, to facilitate understanding of this invention, it is assumed that the spectral image signal is a 6-band color image signal, but this invention is not limited thereto.

### (1-b) Multiband Colorimetric Image Signal

A multiband colorimetric image signal is obtained by adding the profile of the camera used during image pick-up (the spectral sensitivity characteristic, tone characteristic, bias value, and so on of the camera) and information for generating an XYZ colorimetric image signal from a multiband color image signal to a color image signal constituted by at least 4 bands, preferably 6 bands, or more than 6 bands. Hereafter, the information for generating an XYZ colorimetric image signal from a multiband color image signal will be referred to as “D2C” information. D2C indicates determining colorimetry from an input image signal (digital data), and stands for “Data to Colorimetry”, i.e. “D to C”.

When the multiband colorimetric image signal described above is input, the aforementioned camera profile is applied to the multiband colorimetric image signal, thereby eliminating device dependency from the multiband colorimetric image signal. The multiband colorimetric image signal is typically subjected to colorimetric color display without using the illumination conversion technique described above. In other words, display is typically performed so as to reproduce XYZ tristimulus values determined from the multiband colorimetric image signal. However, when the observer wishes to reduce observer metamerism even slightly or when display employing the illumination conversion technique described above is desired, spectral approximation display may be performed, albeit artificially. Hereafter, a technique of performing spectral approximation display on the basis of a multiband colorimetric image signal will be referred to as “pseudo spectral approximation display”.

The D2R information is not attached to the multiband colorimetric image signal, and therefore a spectral reflectance image of the photographed subject cannot be generated directly. Hence, the spectrum of the input illuminant is estimated or assumed. The illumination conversion technique described above is then used to generate and display an image expressing the relative spectral radiance of the photographed subject. Alternatively, an image may be generated by determining the relative spectral radiance of the photographed subject when illuminated by an input illuminant having the estimated or assumed spectrum. Since display is performed by estimating or assuming the spectrum of the input illuminant, as described above, this technique is known as “pseudo spectral approximation display”. According to this pseudo spectral approximation display, an image that appears close to its natural state can be obtained, though it is not always accurate. Hereafter, to facilitate understanding of this invention, it is assumed that the multiband colorimetric image signal is a 6-band color image signal, but this invention is not limited thereto.

### (1-c) Colorimetric Image Signal

A colorimetric image signal includes an image signal expressed by tristimulus values XYZ representing the relative spectral radiance distribution of the photographed subject, or an image signal represented by a colorimetric system such as L*a*b, L*u*v* or L*c*h. A colorimetric image signal is superior to a conventional RGB image signal in that device dependency can be minimized and the color space can be widened, but since spectral information is lost, the problem of observer metamerism may occur. It should be noted that in a broad sense, an sRGB image signal received by a system in which color matching is achieved between devices such as the image input device, the image signal processing device, and the monitor display device may also be considered a colorimetric image signal. Hereafter, to facilitate understanding of this invention, the colorimetric image signal is assumed to be an XYZ color image signal, but this invention is not limited thereto.

### (1-d) RGB Image Signal

An RGB image signal is a so-called device-dependent image signal in which color management is not performed, such as a conventional camera signal. An RGB image signal is an analog or digital image signal in which the respective values of R G B can be defined, and the RGB image signal may be a Y/C separation analog composite video signal, an analog or digital YUV component video signal, and an analog or digital component RGB video signal. Hereafter, to facilitate understanding of this invention, the RGB image signal is assumed to be a digital component RGB video signal, but this invention is not limited thereto.

### 2. Types of Monitor Display Device

### (2-a) Multiple Primary Color Monitor Display Device

A multiple primary color monitor display device is a monitor display device capable of displaying images in at least 4, preferably 6, or more than 6 primary colors. Display characteristic information expressing the display characteristic of the multiple primary color monitor display device includes primary color spectral data, bias spectral data, and tone data. When these data are input into the color conversion processing device 100 by any means, the color conversion processing device 100 performs monitor display characteristic correction processing on an image signal before the image signal is input into the monitor display device 140, as will be described in detail below. As a result, image display exhibiting more accurate color reproduction, which is not dependent on the display characteristic of the multiple primary color monitor display device, can be realized. The multiple primary color monitor display device is capable of displaying images based on any of the spectral image signal, the multiband colorimetric image signal, the colorimetric image signal, and the RGB image signal described above. Hereafter, to facilitate understanding of this invention, a multiple primary color monitor display device is assumed to be a 6-primary color monitor display device using RGBOCP (red, green, blue, orange, cyan, purple) as primary colors, but this invention is not limited thereto.

### (2-b) Colorimetric Monitor Display Device

A colorimetric monitor display device is a monitor display device capable of inputting an image signal represented by tristimulus values such as XYZ and subjecting the input image signal to colorimetric color display. Colorimetric color display means displaying an image so as to reproduce the colorimetry thereof, which is determined from the relative spectral radiance of the photographed subject, i.e. such that the tristimulus values determined from the relative spectral radiance of the photographed subject and the tristimulus values of the image displayed on the monitor display device substantially match. From this point of view, a colorimetric monitor display device is not limited to a monitor display device capable of inputting an XYZ image signal, and also includes a monitor display device capable of converting the XYZ image signal into a unique value (signal) determined from the XYZ values and displaying the resulting image. In a broad sense, a monitor display device which is capable of device-independent display, such as an sRGB monitor display device, or a calibrated RGB monitor display device capable of device-independent display of an image signal such as an input sRGB image signal may also be defined as a colorimetric monitor display device. A colorimetric monitor display device is capable of displaying an image based on a colorimetric image signal or an RGB image signal. Hereafter, to facilitate understanding of this invention, a colorimetric monitor display device is assumed to be a monitor display device capable of inputting an XYZ colorimetric image signal, but this invention is not limited thereto.

Incidentally, a colorimetric monitor display device typically includes a monitor display characteristic correction table in its interior and performs display after subjecting an input colorimetric image signal to monitor display characteristic correction processing. When the colorimetric monitor display device does not have a monitor display characteristic correction function, information relating to the display characteristic of the colorimetric monitor display device may be obtained by a method such as monitor calibration, and the color conversion processing device 100 may perform monitor display characteristic correction processing on the basis of this information before outputting the image signal to the colorimetric monitor display device. In the following description, it is assumed that the colorimetric monitor display device includes a monitor display characteristic correction table in its interior such that display is performed after performing monitor display characteristic correction processing on the input colorimetric image signal, but this invention is not limited thereto.

### (2-c) RGB Monitor Display Device

An RGB monitor display device is an RGB 3-primary color monitor display device such as a television set or conventional monitor display device for a PC (personal computer) which does not have a calibration function and is incapable of device-independent display. An RGB monitor display device is only capable of displaying images based on RGB image signals including composite video signals and component video signals. Hereafter, to facilitate understanding of this invention, it is assumed that an RGB monitor display device is a monitor display device capable of inputting a digital component RGB video signal, but this invention is not limited thereto.

### 3. Types of Displayed Image

### (3-a) Images Displayed on Multiple Primary Color Monitor Display Device

A case in which a multiple primary color monitor display device is connected to the color conversion processing device 100 as the monitor display device 140 will be described.

(3-a-1) Spectral Approximation Reproduction Display

When the input image signal is a spectral image signal, the color conversion processing device 100 applies the aforementioned camera profile to the spectral image signal to remove the device dependency of the camera from the spectral image signal. Next, illumination conversion processing is performed on the basis of the D2R information and observing illuminant information. Monitor display characteristic correction processing is then performed, whereupon an image signal (RGBOCP signal) for realizing spectral approximation reproduction display is output to the monitor display device 140.

(3-a-2) Pseudo Spectral Approximation Display Based on Multiband Colorimetric Image Signal

In this type of display, the input image signal is a multiband colorimetric image signal, but a user (the person observing the images displayed on the monitor display device) desires pseudo spectral approximation display. The color conversion processing device 100 applies the camera profile to the multiband colorimetric image signal to generate a corrected multiband colorimetric image signal, whereupon the D2C information is applied to generate a multiband colorimetric image of the photographed subject. Next, the color conversion processing device 100 estimates (or assumes) the spectral reflectance of the photographed subject from the multiband colorimetric image signal determined in the manner described above. On the basis of the estimated spectral reflectance of the photographed subject and information regarding the observing illuminant, the color conversion processing device 100 performs illumination conversion processing. Monitor display characteristic correction processing is then performed, whereupon an image signal (RGBOCP signal) for realizing pseudo spectral approximation display is output to the monitor display device 140.

(3-a-3) Pseudo Spectral Approximation Display Based on XYZ Colorimetric Image Signal

When the input image signal is an XYZ colorimetric image signal but the user desires pseudo spectral approximation display, the color conversion processing device 100 estimates (or assumes) the spectral reflectance of the photographed subject from the XYZ colorimetric image signal. The color conversion processing device 100 performs illumination conversion processing on the basis of the estimated spectral reflectance of the photographed subject and information regarding the observing illuminant, and then performs monitor display characteristic correction processing, whereupon an image signal (RGBOCP signal) for realizing pseudo spectral approximation display is output to the monitor display device 140.

(3-a-4) Colorimetric Color Display Based on Multiband Colorimetric Image Signal

The color conversion processing device 100 applies the camera profile to an input multiband colorimetric image signal, and then applies the D2C information to generate an XYZ colorimetric image signal. Then, on the basis of the XYZ colorimetric values, the color conversion processing device 100 performs processing to convert the XYZ colorimetric values into 6 primary colors (RGBOCP) for input into the monitor display device 140. Monitor display characteristic correction processing is then performed, whereupon an image signal (RGBOCP signal) for realizing multiband colorimetric color display is output to the monitor display device 140. This colorimetric color display based on multiband colorimetric values may be realized in a unicast format. For example, observing illuminant information is transmitted to an image signal transmission server from a client (the image signal receiving side), illumination conversion processing is performed on the server side, and the processing result is output to the client side as a multiband colorimetric image signal.

(3-a-5) Colorimetric Color Display Based on XYZ Colorimetric Image Signal

On the basis of an input XYZ colorimetric image signal, the color conversion processing device 100 performs processing (3-6 conversion processing) to convert the XYZ colorimetric image signal into 6 primary colors (RGBOCP) for input into the monitor display device 140. Monitor display characteristic correction processing is then performed, whereupon an image signal (RGBOCP signal) for realizing XYZ colorimetric color display is output to the monitor display device 140. During the 3-6 conversion processing, a LUT (look-up table) generated in advance on the basis of monitor profile information and the like is referenced.

(3-a-6) RGB Display Based on Multiband or XYZ Colorimetric Image Signal

When the input image signal is a multiband colorimetric image signal, the color conversion processing device 100 applies the camera profile to the input multiband colorimetric image signal, and then applies the D2C information to generate an XYZ colorimetric image signal. The color conversion processing device 100 further generates an RGB image signal by applying a 3×3 conversion matrix to the XYZ colorimetric image signal. Alternatively, when the input image signal is an XYZ colorimetric image signal, the color conversion processing device 100 generates an RGB image signal by applying a 3×3 conversion matrix to the input XYZ colorimetric image signal. The color conversion processing device 100 then uses the following equation to generate an image signal (RGBOCP signal) for output to the monitor display device 140 from the RGB image signal generated in this manner. More specifically, when the RGB values of the generated RGB image signal are represented by r, g, b, respectively, and the RGBOCP values of the RGBOCP image signal to be output are represented by R, G, B, O, C, P, respectively, the R, G, B, O, C, P values can be determined as follows.

R=r/2, O=r/2

G=g/2, C=g/2

B=b/2, P=b/2

Needless to say, the above equation is merely an example, and the respective R, G, B, O, C, P values may be determined from r, g, b using an appropriate equation, a conversion matrix, or a LUT. The color conversion processing device 100 performs monitor display characteristic correction processing on the image signal (RGBOCP signal) obtained in this manner, and then outputs an image signal for displaying the RGB image signal to the monitor display device 140.

(3-a-7) RGB Display Based on RGB Image Signal

When display based on an RGB image signal is performed on a monitor display device having RGBOCP as primary colors, the color conversion processing device 100 generates an image signal (RGBOCP signal) for output to the monitor display device 140 from the input RGB image signal using the following equation. More specifically, when the RGB values of the input RGB image signal are represented by r, g, b, respectively, and the RGBOCP values of the RGBOCP image signal to be output are represented by R, G, B, O, C, P, respectively, the R, G, B, O, C, P values can be determined as follows.

R=r/2, O=r/2

G=g/2, C=g/2

B=b/2, P=b/2

Needless to say, the above equation is merely an example, and the respective R, G, B, O, C, P values may be determined from r, g, b using an appropriate equation, a conversion matrix, or a LUT. The color conversion processing device 100 performs monitor display characteristic correction processing on the image signal (RGBOCP signal) obtained in this manner, and then outputs an image signal for displaying the RGB image signal to the monitor display device 140.

### (3-b) Images Displayed on Colorimetric Monitor Display Device

A case in which a colorimetric monitor display device is connected to the color conversion processing device 100 as the monitor display device 140 will be described.

(3-b-1) Colorimetric Color Display Based on Spectral Image Signal

When the input image signal is a spectral image signal, the color conversion processing device 100 applies the camera profile to the spectral image signal to remove the device dependency of the camera from the spectral image signal. Next, the color conversion processing device 100 performs illumination conversion processing on the basis of the D2R information and observing illuminant information, generates an XYZ colorimetric image signal through application of a color matching function, and outputs the generated XYZ colorimetric image signal to the colorimetric monitor display device.

(3-b-2) Colorimetric Color Display Based on Multiband Colorimetric Image Signal

The color conversion processing device 100 applies the camera profile and the D2C information to the input multiband colorimetric image signal to generate an XYZ colorimetric image signal, and outputs the generated XYZ colorimetric image signal to the colorimetric monitor display device.

(3-b-3) Colorimetric Color Display Based on XYZ Colorimetric Image Signal

The color conversion processing device 100 outputs an input XYZ colorimetric image signal to the colorimetric monitor display device without performing any particular processing on the XYZ colorimetric image signal.

(3-b-4) RGB Display Based on RGB Image Signal

When display based on an RGB image signal is performed on a colorimetric monitor display device, the color conversion processing device 100 generates an image signal (XYZ signal) for output to the monitor display device 140 by applying a 3×3 conversion matrix to the input RGB image signal. In this processing, an XYZ signal is generated from an RGB image signal, but since the original RGB image signal is not a colorimetric image signal, the obtained XYZ signal does not possess colorimetry.

### (3-c) Images Displayed on RGB Monitor Display Device

A case in which an RGB monitor display device is connected to the color conversion processing device 100 as the monitor display device 140 will be described.

(3-c-1) RGB Display Based on Spectral Image Signal

When the input image signal is a spectral image signal, the color conversion processing device 100 applies the camera profile to the spectral image signal to remove the device dependency of the camera from the spectral image signal. The color conversion processing device 100 then performs illumination conversion processing on the basis of the D2R information and observing illuminant information, and generates an XYZ colorimetric image signal through application of a color matching function. The color conversion processing device 100 also generates an RGB image signal by applying a 3×3 conversion matrix to the XYZ colorimetric image signal, and outputs the generated RGB image signal to the monitor display device 140. At this time, the color conversion processing device 100 may apply LUT conversion processing for correcting the monitor display characteristic to the RGB image signal before outputting it to the monitor display device 140.

(3-c-2) RGB Display Based on Multiband Colorimetric Image Signal

The color conversion processing device 100 applies the camera profile and the D2C information to the input multiband colorimetric image signal to generate an XYZ colorimetric image signal. The color conversion processing device 100 also generates an RGB image signal by applying a 3×3 conversion matrix to the XYZ colorimetric image signal, and outputs the generated RGB image signal to the monitor display device 140. At this time, the color conversion processing device 100 may apply LUT conversion processing for correcting the monitor display characteristic to the RGB image signal before outputting it to the monitor display device 140.

(3-c-3) RGB Display Based on XYZ Colorimetric Image Signal

The color conversion processing device 100 generates an RGB image signal by applying a 3×3 conversion matrix to an input XYZ colorimetric image signal, and outputs the generated RGB image signal to the monitor display device 140. At this time, the color conversion processing device 100 may apply LUT conversion processing for correcting the monitor display characteristic to the RGB image signal before outputting it to the monitor display device 140.

(3-c-4) RGB Display Based on RGB Image Signal

The color conversion processing device 100 outputs an input RGB image signal to the monitor display device 140 without performing any particular processing on the RGB image signal. Alternatively, the color conversion processing device 100 may apply LUT conversion processing for correcting the monitor display characteristic to the RGB image signal before outputting it to the monitor display device 140.

4. Examples in Which Image Display Format Differs from Intended Image Display Format

The types of monitor display devices that can be connected to the color conversion processing device 100 and the types of image signals that can be input into the color conversion processing device 100 were described above. In addition, the display format in which an image is displayed was described in accordance with the combination of the type of image signal input into the color conversion processing device 100 and the type of monitor display device connected to the color conversion processing device 100. However, in situations such as those described below, image display may not always be performed in the display formats described above. These situations occur when the possibility of a reduction in the quality of the displayed image arises, for example when the noise is caused in an image displayed on the monitor display device 140 or when a color difference increases.

First, a case in which noise occurs in the image will be described. The noise described in this specification signifies block noise-like appearance caused by unnatural tone jumping, which is recognizable in the image displayed on the monitor display device. When the displayed image is a static image, this noise may be recognized in parts where the tone varies gradually. When the displayed image is a moving image, this noise may be recognized in parts where the tone of an image (frame) displayed momentarily varies gradually. This noise may also be experienced as a flicker (screen flickering) like appearance when a comparatively gradual color change occurs in an identical pixel position or nearby pixel positions between temporally adjacent images.

The likelihood with which this noise occurs differs according to the displayed color. As will be described in detail below, the color conversion processing device 100 performs color conversion processing on the input image signal to determine successively whether or not a color displayed by the monitor display device 140 is a color in which noise may occur. Having determined that the displayed color is a color in which noise may occur, the color conversion processing device 100 performs color conversion processing using a different color conversion method, and then outputs a generated processed display image signal to the monitor display device 140.

Next, a case in which the color difference increases will be described. When image display based on a colorimetric image signal is performed, a color difference occurring between the color defined by the colorimetric image signal and the color reproduced by the monitor display device may increase depending on the specifications of the monitor display device. One cause of this is the magnitude of the color gamut that can be reproduced by the monitor display device. In other words, when the color defined by the colorimetric image signal is outside the reproducible gamut of the monitor display device, a color difference occurs. When the color difference exceeds a predetermined magnitude, noise becomes evident in the displayed image. A color difference may also occur when there is a difference in tone resolution (quantization resolution) between the colorimetric image signal and the image reproduced by the monitor display device. For example, when the colorimetric image signal is a 12-bit XYZ signal whereas the monitor display device has only an 8-bit resolution in relation to each of XYZ, a color difference may occur. When the color difference exceeds a predetermined magnitude as described above, RGB display is preferably performed instead of colorimetric color display.

Here, examples in which display is performed in a different display format (method) when the noise and color difference are predicted will be described in relation to display formats (methods) such as spectral approximation reproduction display, pseudo spectral approximation display, and colorimetric color display, which are determined in advance on the basis of the combination of the type of the input image signal and the type of the monitor display device.

### (4-a) Images Displayed on Multiple Primary Color Monitor Display Device

A case in which a multiple primary color monitor display device is connected to the color conversion processing device 100 as the monitor display device 140 will be described. When a multiple primary color monitor display device is connected to the color conversion processing device 100 as the monitor display device 140, the following order of precedence of display method is set in the monitor display device 140.
1) Spectral approximation reproduction display
2) Pseudo spectral approximation display based on multiband colorimetric image signal
3) Pseudo spectral approximation display based on XYZ colorimetric image signal
4) Colorimetric color display based on multiband colorimetric image signal
5) Colorimetric color display based on XYZ colorimetric image signal
6) RGB display based on multiband or XYZ colorimetric image signal
7) RGB display based on RGB image signal

In accordance with this order of precedence, the color conversion processing device 100 attempts display in order from the display method having the highest order of precedence of the possible display methods while monitoring the type of input image signal and the possibility of the noise and color difference.

(4-a-1) Input Image Signal: Spectral Image Signal

When the input image signal is a spectral image signal, color conversion processing is usually performed to realize spectral approximation reproduction display, in accordance with the order of display precedence described above. However, when the noise is predicted, the color conversion processing device 100 attempts colorimetric color display based on multiband colorimetry. When the possibility of the noise or a color difference that causes deterioration of the quality of the displayed image remains, the color conversion processing device 100 switches to RGB display. In this case, an XYZ colorimetric signal is generated from the 6-band spectral image signal, an RGB signal is generated from the XYZ colorimetric signal, and an RGBOCP display image signal is generated from the RGB signal. The method described above in (3-a-7) may be used as the method of generating the RGBOCP display image signal from the RGB signal.

(4-a-2) Input Image Signal: Multiband Colorimetric Image Signal

When the input image signal is a multiband colorimetric image signal and the user desires pseudo spectral approximation display, color conversion processing is performed to realize pseudo spectral approximation display based on multiband colorimetry. However, when the noise is predicted, the color conversion processing device 100 attempts colorimetric color display based on multiband colorimetry. Colorimetric color display based on multiband colorimetry is also used as a display format when the input image signal is a multiband colorimetric image signal and the user does not desire pseudo spectral approximation display. When, as a result of the attempt to perform colorimetric color display based on multiband colorimetry, the possibility of the noise or a color difference that causes deterioration of the quality of the displayed image is predicted, the color conversion processing device 100 switches to RGB display. In this case, an XYZ colorimetric signal is generated from the multiband colorimetric image signal, an RGB signal is generated from the XYZ colorimetric signal, and an RGBOCP display image signal is generated from the RGB signal. The method described above in (3-a-7) may be used as the method of generating the RGBOCP display image signal from the RGB signal.

(4-a-3) Input Image Signal: XYZ Colorimetric Image Signal

When the input image signal is an XYZ colorimetric image signal and the user desires pseudo spectral approximation display, color conversion processing is performed to realize pseudo spectral approximation display based on XYZ colorimetry. However, when the noise is predicted, the color conversion processing device 100 attempts colorimetric color display based on XYZ colorimetry. Colorimetric color display based on XYZ colorimetry is also used as a display format when the input image signal is an XYZ colorimetric image signal and the user does not desire pseudo spectral approximation display. When, as a result of the attempt to perform colorimetric color display based on XYZ colorimetry, the possibility of the noise or a color difference that causes deterioration of the quality of the displayed image is predicted, the color conversion processing device 100 switches to RGB display. In this case, an RGB signal is generated from the XYZ colorimetric signal, and an RGBOCP display image signal is generated from the RGB signal. The method described above in (3-a-7) may be used as the method of generating the RGBOCP display image signal from the RGB signal.

### (4-b) Images Displayed on Colorimetric Monitor Display Device

A case in which a colorimetric monitor display device is connected to the color conversion processing device 100 as the monitor display device 140 will be described. When a colorimetric monitor display device is connected to the color conversion processing device 100 as the monitor display device 140, the following order of precedence of display method is set in the monitor display device 140.
1) Colorimetric color display based on spectral image signal
2) Colorimetric color display based on multiband colorimetric image signal
3) Colorimetric color display based on XYZ colorimetric image signal
4) RGB display based on spectral image signal, multiband colorimetric image signal, or XYZ colorimetric image signal
5) RGB display based on RGB image signal

In accordance with this order of precedence, the color conversion processing device 100 attempts display in order from the display method having the highest order of precedence of the possible display methods while monitoring the type of the input image signal and the possibility of the noise and color difference.

(4-b-1) Input Image Signal: Spectral Image Signal

When the input image signal is a spectral image signal, color conversion processing is usually performed to realize XYZ colorimetric color display in accordance with the procedure described above in (3-b-1). Here, when the possibility of the noise or a color difference that causes deterioration of the quality of the displayed image is predicted, an RGB display image signal is generated from the XYZ colorimetric signal obtained in the procedure.

(4-b-2) Input Image Signal: Multiband Colorimetric Image Signal

When the input image signal is a multiband colorimetric image signal, color conversion processing is usually performed to realize XYZ colorimetric color display in accordance with the procedure described above in (3-b-2). When, as a result, the possibility of the noise or a color difference that causes deterioration of the quality of the displayed image is predicted, an RGB display image signal is generated from the XYZ colorimetric signal obtained in the procedure.

(4-b-3) Input Image Signal: XYZ Colorimetric Image Signal

When the input image signal is an XYZ colorimetric image signal, usually no particular color conversion processing is performed. However, when the possibility of the noise or a color difference that causes deterioration of the quality of the displayed image is predicted, an RGB display image signal is generated from the XYZ colorimetric signal.

The processing described above, which is performed when the image display format differs from intended image display format, may be applied to an entire displayed image (the entire image in a frame in the case of a moving image). Alternatively, noise and color difference generation may be predicted in pixel-by-pixel such that the display format is switched in pixel-by-pixel.

Referring back to FIG. 1, the constitution of the color conversion processing device 100 will be described. The color conversion processing device 100 may be implemented as a set top box, as noted above, or constituted by a computer and software or firmware executed on the computer. Alternatively, the color conversion processing device 100 may be implemented as an inbuilt unit of the monitor display device. In this case, the monitor display device is limited to a single type, and therefore the color conversion processing device 100 does not determine the type of the connected monitor display device during the color conversion processing described above.

The color conversion processing device 100 comprises a signal input unit 102, a signal separation unit 104, a characteristic information gathering unit 106, a color conversion processing method selection unit 112, a color conversion processing execution unit 114, an illumination characteristic input unit 116, and a monitor information input unit 118. The signal input unit 102 receives an input image signal from the image signal output device 150 and transmits the input image signal to the signal separation unit 104. The signal separation unit 104 separates the input image signal into profile data and an image signal, and transmits the profile data and the image signal to the characteristic information gathering unit 106 and the color conversion processing execution unit 114, respectively. The profile data include various data corresponding to the type of the input image signal. For example, a spectral image signal includes input illumination spectrum information, a camera profile, D2R information, and so on as the profile data. Further, a multiband colorimetric image signal includes a camera profile, D2C information, and so on as the profile data.

The characteristic information gathering unit (color conversion characteristic information input unit) 106 comprises an image characteristic information gathering unit 108 including a profile extraction unit 120 and an algorithm model determination unit 122, and an observing environment information gathering unit 110. The profile extraction unit 120 extracts image characteristic information (color conversion characteristic information), such as the input illumination spectrum information, the camera profile, and the D2R information, from the profile data received from the signal separation unit 104, and transmits the extracted information to the algorithm model determination unit 122. The algorithm model determination unit 122 determines the type of color conversion processing to be performed on the input image signal, or in other words the type of algorithm model to be applied, on the basis of the data received from the profile extraction unit 120, and outputs the data, together with a determination result, to the color conversion processing method selection unit 112. For example, in an algorithm model for performing spectral reproduction, the profile includes D2R or D2C information. Therefore, when the profile includes the D2R or D2C information, the algorithm model relating to the input image signal is determined to be an algorithm model for performing spectral approximation reproduction display or pseudo spectral approximation display. When the required information for the spectral reproduction algorithm model is not all present but information for estimating the colorimetry of the photographed subject is present, it is determined as an algorithm model for performing colorimetric image display. When information enabling calculation of the relative spectral radiance and colorimetry is not included, it is determined as an algorithm model for performing RGB display.

Monitor characteristic information (display characteristic information, color conversion characteristic information), such as the types of images that can be displayed by the monitor display device 140 connected to the color conversion processing device 100 and a display profile, is input into the monitor information input unit (display characteristic information input unit) 118. The display profile includes the primary color spectra of the monitor display device 140, bias spectrum data, TRC (Tone Reproduction Curve) data, and so on. The monitor characteristic information is recorded on a storage medium such as a memory card or a CD-ROM so that the information may be read by the monitor information input unit 118. Alternatively, information such as a code from which the maker and product name of the connected monitor display device can be identified may be input by having a user operate an operation panel provided on the main body of the color conversion processing device 100 or a remote control device. In this case, the color conversion processing device 100 is capable of extracting monitor characteristic information corresponding to the code or other information input in the manner described above from a database stored in the interior thereof. Alternatively, the color conversion processing device 100 may input the required information by accessing an Internet site capable of providing the monitor characteristic information corresponding to the input code or other information. Further, the monitor display device 140 may itself store the monitor characteristic information such that the monitor characteristic information is transmitted from the monitor display device 140 to the color conversion processing device 100.

Information enabling identification of the spectrum of the observing illuminant, for example observing illuminant information such as a code enabling identification of the maker and product name of an illumination device disposed in the observing environment, is input into the illumination characteristic input unit (observing illuminant characteristic input unit) 116. A spectrum corresponding to the input observing illuminant information may then be extracted from a database stored in the interior of the color conversion processing device 100. Alternatively, the color conversion processing device 100 may input the required information by accessing an Internet site capable of providing a spectrum corresponding to the input observing illuminant information. Further, the user may input the observing illuminant information by operating an operating panel provided in the main body of the color conversion processing device 100 or a remote control device. Alternatively, a storage medium such as a memory card or a CD-ROM recorded with the observing illuminant information may be attached to the color conversion processing device 100 such that the information on the storage medium is read automatically. Further, the spectrum of the observing illuminant may be set arbitrarily by the user. In this case, the currently set spectrum of the observing illuminant may be displayed on a graph, and the user may modify the profile of the spectrum by operating a mouse, a remote control device, or similar.

In addition to the above, or alternatively, a spectrophotometry unit (observing illuminant characteristic measurement unit) capable of measuring the relative spectral radiance of the observing illuminant may be provided, and a measurement result output from the spectrophotometry unit may be input into the illumination characteristic input unit 116. When a spectrophotometry unit is provided, the spectral characteristics of external light entering through a room window may also be reflected in the color characteristics of the displayed image. Further, in an observing environment containing various different types of illumination light, display that reflects the influence of the observing illuminant more accurately can be achieved in accordance with the lit/unlit state of the illumination light, the light quantity ratio, and so on, and moreover, it becomes possible to respond to temporal variation in the relative spectral radiance of light emitted from an electric light bulb, a fluorescent tube, and so on.

The spectrophotometry unit may be formed by fixing an impinge end of an optical fiber in a translucent white dome-shaped light receiving portion and arranging a collimation lens, a slit, a grating, and a line sensor or an area sensor near the exit end of the optical fiber. Light emitted from the optical fiber is formed into thin parallel beams by the collimation lens. The thin parallel beams are input into the grating, whereupon light diffracted (dispersed) by the grating is led to the line sensor or area sensor. Alternatively, the spectrophotometry unit may employ a photometry unit having a light receiving unit that is sensitive to RGB or YCM light to measure the relative spectral radiance of the observing illuminant simply.

The monitor characteristic information and information such as the observing environment spectrum obtained in the manner described above are transmitted to the color conversion processing method selection unit 112 via the observing environment information gathering unit 110. The color conversion processing method selection unit 112 extracts a possible color conversion method on the basis of the information input from the characteristic information gathering unit 106, and selects an optimum color conversion method therefrom in accordance with the predetermined order of precedence. The color conversion processing method selection unit 112 then outputs the optimum color conversion method selected in the manner described above, the possible color conversion methods, and information such as D2R and D2C, which is required during color conversion processing, to the color conversion processing execution unit 114.

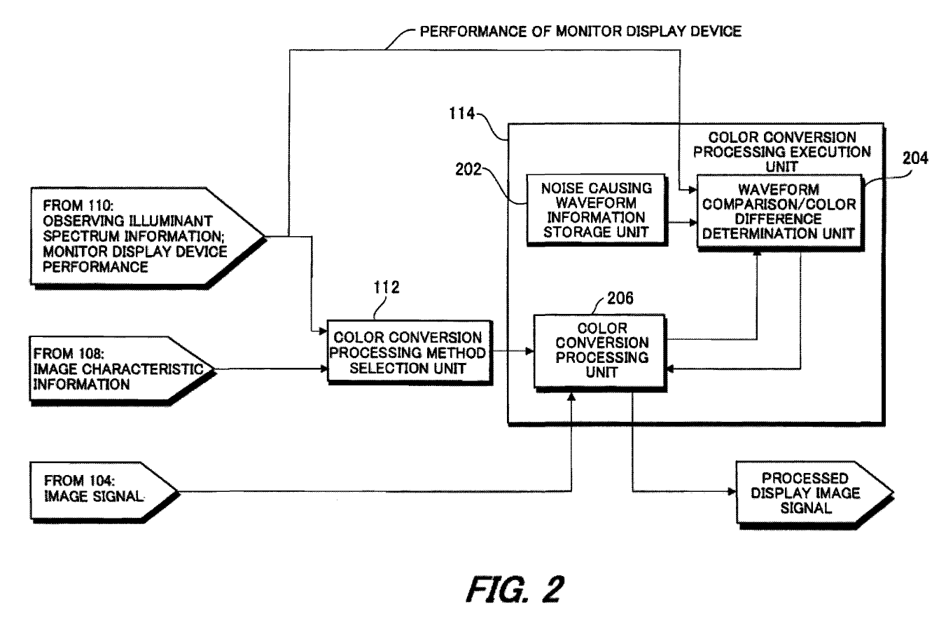

Referring to FIG. 2, which is a schematic block diagram showing the internal constitution of the color conversion processing execution unit 114, the color conversion processing execution unit 114 will be described in detail. The color conversion processing execution unit 114 comprises a noise causing waveform information storage unit 202, a waveform comparison/color difference determination unit 204, and a color conversion processing unit 206. The color conversion processing unit 206 implements color conversion processing on an image signal on the basis of the color conversion method input from the color conversion processing method selection unit 112, and outputs a processing result to the waveform comparison/color difference determination unit 204. Information relating to the performance of the monitor display device, which is required during color difference determination, is also input into the waveform comparison/color difference determination unit 204 from the observing environment information gathering unit 110. The waveform comparison/color difference determination unit 204 determines whether or not the color conversion result output from the color conversion processing unit 206 indicates that noise is likely to occur by referring to noise causing waveform information stored in the noise causing waveform information storage unit 202. The waveform comparison/color difference determination unit 204 also determines a color difference when the signal received from the color conversion processing unit 206 is a colorimetric image signal.

Here, the noise causing waveform information stored in the noise causing waveform information storage unit 202 will be described. Information such as the following may be recorded in a table as noise causing waveform information relating to a 6-primary color display device, for example. When the respective colors of color patches in 24 colors constituting a Gretag Macbeth color chart, which is used typically as a standard color chart, are output to the 6-primary color video display device as an image signal for realizing multiple primary color spectral display, the degree of noise (the noise occurring tendency) in each patch is registered. For example, the degree of variation in the display image signal when the distribution of the spectrum representing the colors of the respective patches varies slightly is recorded in the table in the form of a square sum of variation in the respective signal values of the six primary colors.

More specifically, when the intensities of the six primary colors constituting a color Cᵢ (where i=1, 2, . . . , 24) of a certain color patch are represented by Eᵢ₁, Eᵢ₂, . . . , Eᵢ₆, the 24 colors may be represented respectively by

Cᵢ=f[Eᵢ₁, Eᵢ₂, Eᵢ₃, Eᵢ₄, Eᵢ₅, Eᵢ₆]

Cᵢ is partially differentiated by Eᵢ₁, Eᵢ₂, Eᵢ₃, Eᵢ₄, Eᵢ₅, Eᵢ₆, respectively, to determine

∂Cᵢ/∂Eᵢ₁, ∂Cᵢ/∂Eᵢ₂, ∂Cᵢ/∂Eᵢ₃,

∂Cᵢ/∂Eᵢ₄, ∂Cᵢ/∂Eᵢ₅, ∂Cᵢ/∂Eᵢ₆

whereupon the square sums thereof are determined and recorded in the table. When a recorded square sum is large, this indicates that the color of the color patch is sensitive to spectral component variation, and may therefore be considered vulnerable to tone jumping. When tone jumping occurs, noise is more likely to become evident.

Similarly, the tables are prepared both for the cases the colorimetry values of the 24-color color patches are reproduced through pseudo spectral approximation and are reproduced with colorimetric values.

The waveform comparison/color difference determination unit 204 compares the color conversion result output from the color conversion processing unit 206 with the table stored in the noise causing waveform information storage unit 202 to determine the presence of noise. Here, a case in which the number of dimensions of the spectral space during reproduction of a 6-band spectral image is 81 (obtained by dividing a visible light band from 380 nm to 780 nm into 5 nm intervals) will be described as an example. The D2R information included in the input image signal may take the form of a matrix obtained by converting a 6-dimension signal into 81 dimensions, for example. When each band of the input image signal has an 8-bit tone, the signal may take a value from 0 to 255 (2 to the power of 8). The number of combinations of the values that may be taken by a 6-band input image signal is therefore 256 to the power of 6=2⁴⁸.

A spectral waveform obtained by multiplying the observing illumination spectrum by a reflectance obtained as a result of multiplying D2R by all of these combinations (2⁴⁸) is then compared to the spectrum of the 24-color color patches. NRMSE (Normalized Root Mean Square Error) may be used as the comparison method at this time. The degrees of noise in the color patches determined to have the closest waveforms are totaled, and this total may be employed as a predicted value of the noise occurring amount.

This procedure is used to determine the noise occurring amount with respect to each of spectral approximation reproduction display, pseudo spectral approximation display based on multiband colorimetry values, pseudo spectral approximation display based on XYZ colorimetry values, and colorimetric color display based on XYZ colorimetry values. Further, a color difference is determined in relation to a colorimetric image signal. Then, on the basis of the magnitudes of the determined noise and color difference, the display method having the highest order of precedence (the display method having the best color reproduction performance) is selected from among the display methods with which the noise and color difference are held within a tolerance. The tolerance may be set appropriately by the user. At this time, a default value may be set in advance, and the default value may be applied when the user does not perform a tolerance modification operation. It should be noted that various degrees of noise are predicted in all of the display methods, and therefore the waveform comparison/color difference determination unit 204 may perform processing whereby the display method having the highest order of precedence (the best color reproduction performance) is selected when the noise level difference between display methods is smaller.

The waveform comparison/color determination unit 204 determines noise, and if necessary color difference, in relation to the processed image signal received from the color conversion processing unit 206 in the manner described above, and transmits a determination result to the color conversion processing unit 206. On the basis of the determination result transmitted from the waveform comparison/color difference determination unit 204, the color conversion processing unit 206 outputs a processed display image signal to the monitor display device 140 as is when the noise and color difference are not predicted. When the noise and color difference are predicted, on the other hand, the color conversion processing unit 206 modifies the color conversion processing method, processes the input image signal, and then outputs the processed display image signal to the monitor display device 140.

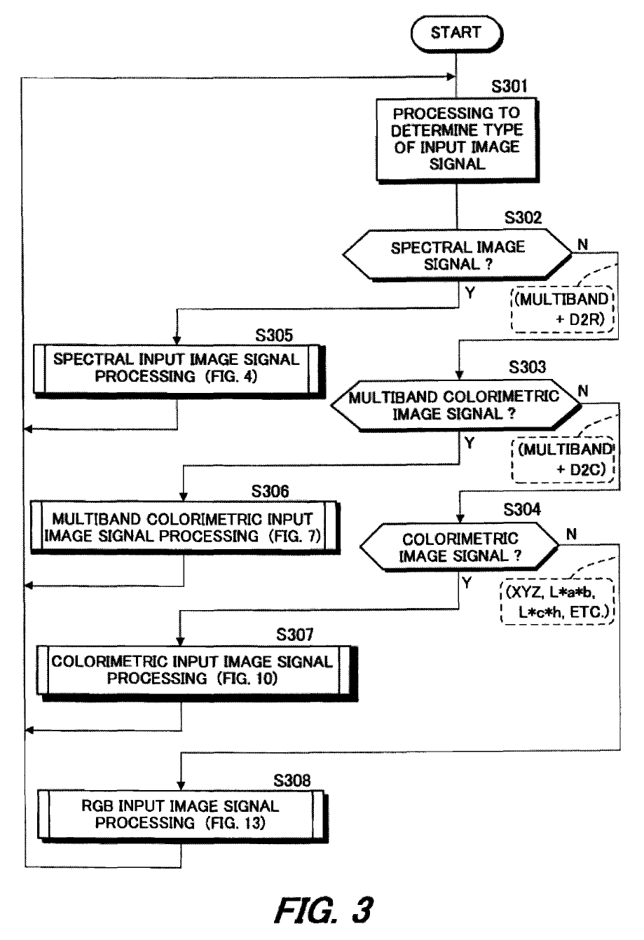

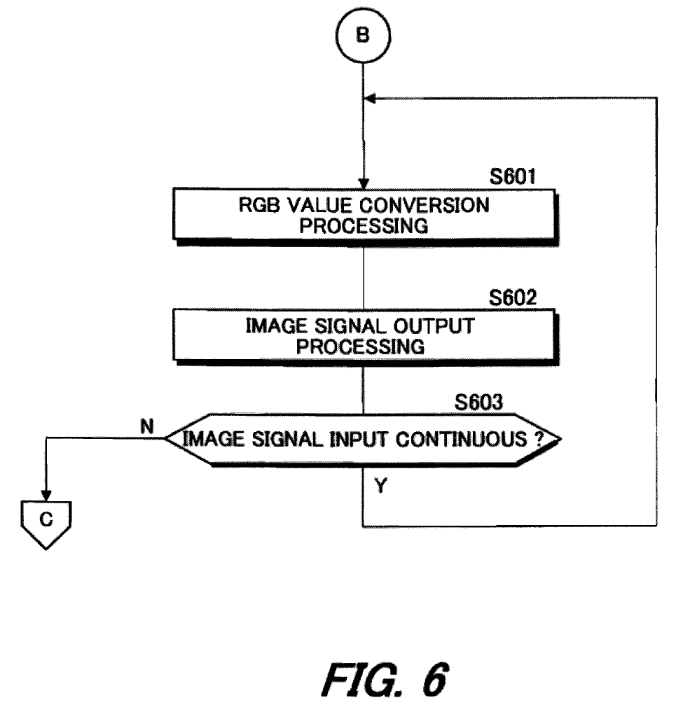

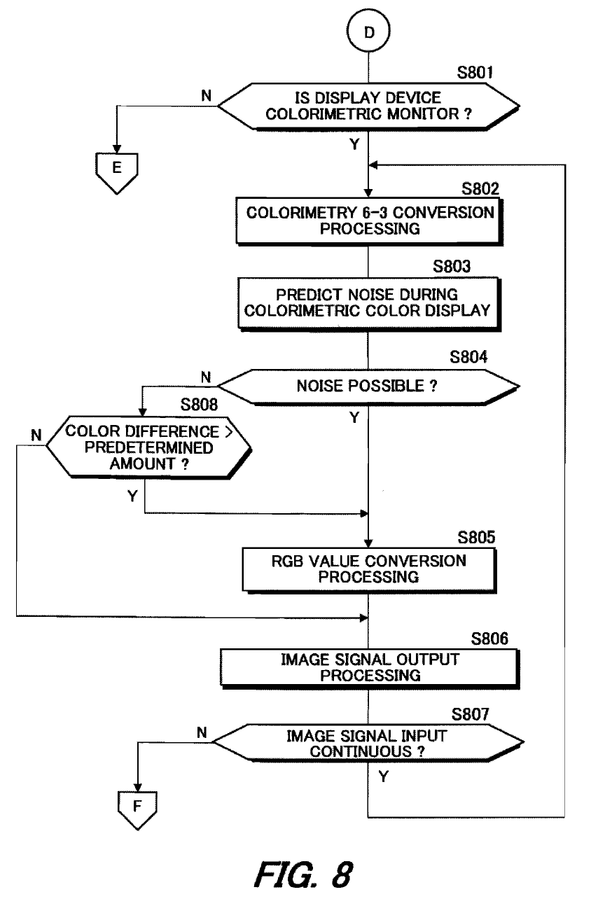

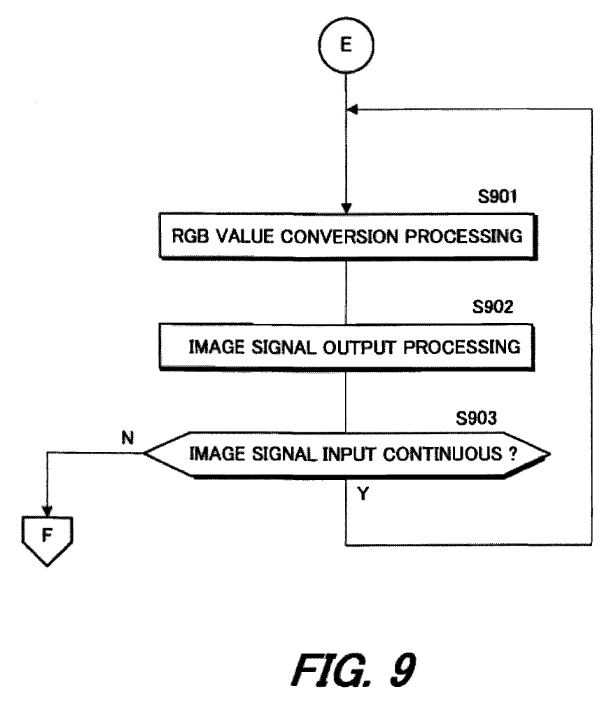

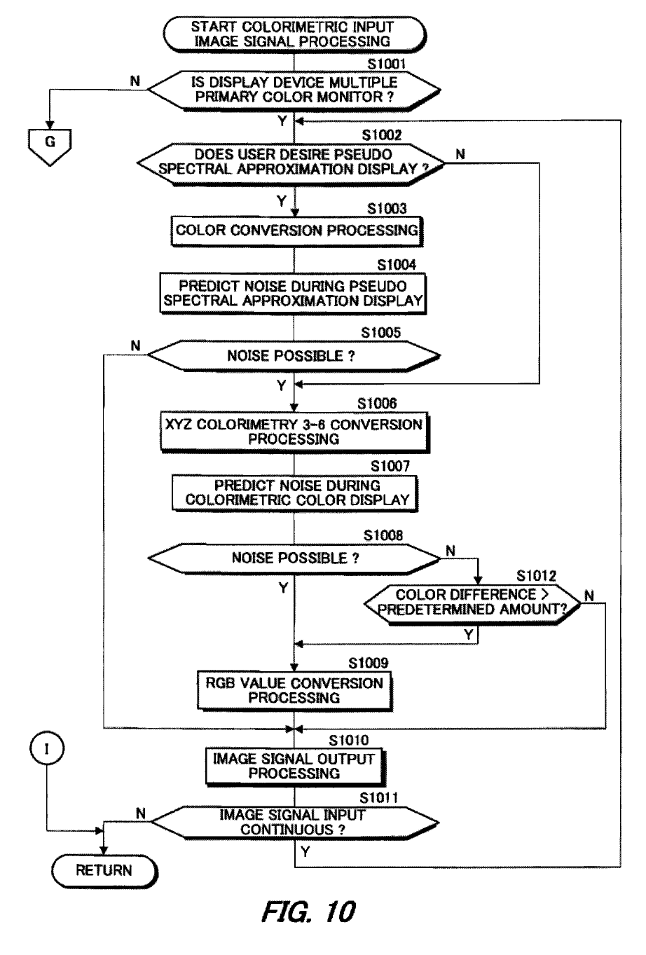

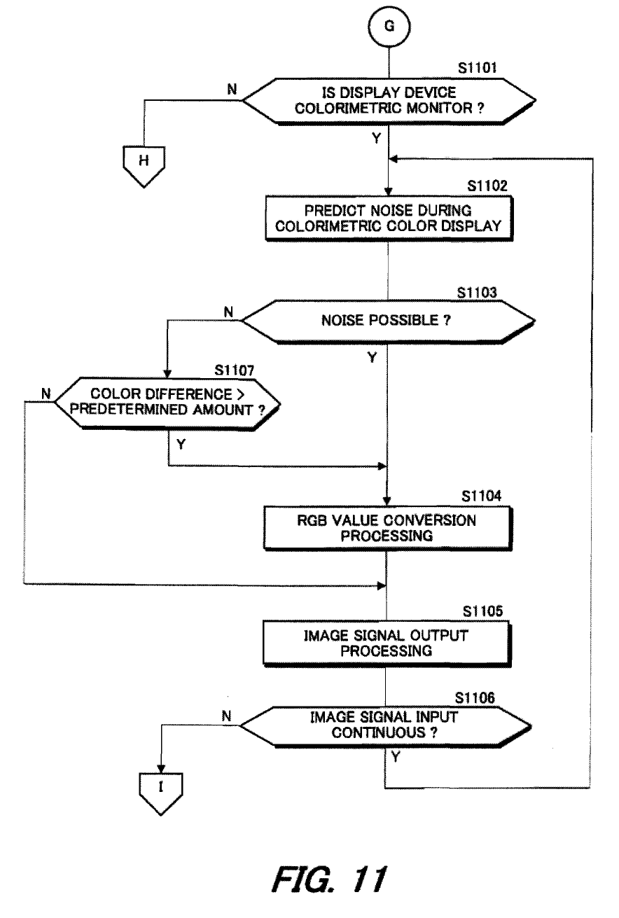

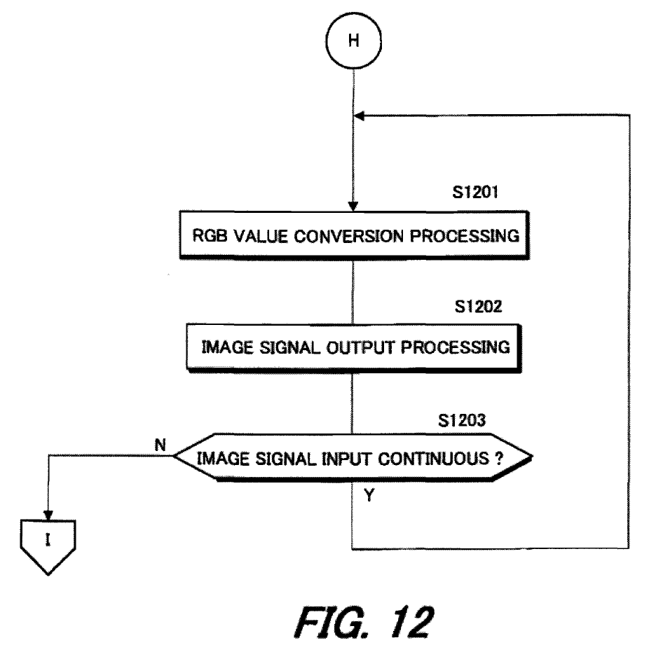

FIGS. 3 to 13 are flowcharts showing examples of the color conversion processing procedure described above, which is executed by the color conversion processing device 100. The color conversion processing procedures executed by the color conversion processing device 100 according to an embodiment of this invention will be described below with reference to FIGS. 3 to 13. It should be noted that in the flowcharts of FIGS. 3 to 13, when the drawing number is a single digit (FIGS. 3 to 9), the 100 unit numeral following the step number S matches the drawing number, and when the drawing number is two digits (FIGS. 10 to 13), the two-digit numeral expressed by the 1000 unit numeral and the 100 unit numeral matches the drawing number. For example, a processing step S301 is shown in FIG. 3, and a processing step S1201 is shown in FIG. 12.

[Main Flow]

A main flow of the color conversion processing will be described with reference to FIG. 3. In S301, the color conversion processing device 100 performs processing to determine the type of the input image signal. As described above, this determination processing is performed on the basis of the types of information included in the input image signal (the D2R information, the D2C information, the profile data, and so on).

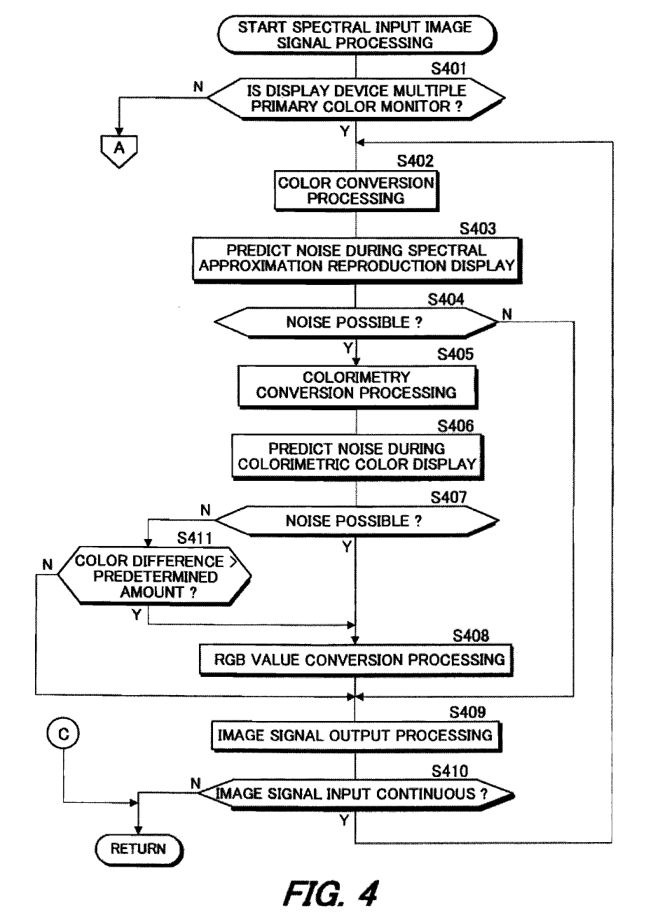

In S302, the color conversion processing device 100 determines whether or not the input image signal is a spectral image signal. When the determination is affirmative, the process bifurcates to the processing of S305, in which spectral input image signal processing shown in FIGS. 4 to 6 is executed. The process then returns to S301. The determination of S302 is affirmative when the input image signal is a multiband image signal and includes the D2R information and so on. When the determination of S302 is negative, the color conversion processing device 100 bifurcates to the processing of S303, in which processing to be described below is performed.

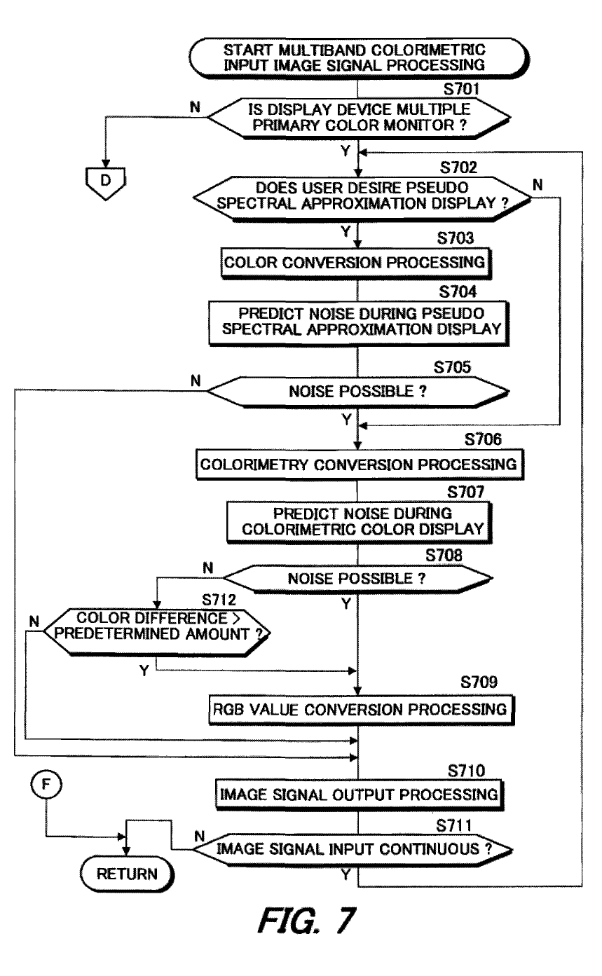

In S303, the color conversion processing device 100 determines whether or not the input image signal is a multiband colorimetric image signal. When the determination is affirmative, the process bifurcates to the processing of S306, in which multiband colorimetric input image signal processing shown in FIGS. 7 to 9 is executed. The process then returns to S301. The determination of S303 is affirmative when the input image signal is a multiband image signal and includes the D2C information and so on. When the determination of S303 is negative, the color conversion processing device 100 bifurcates to the processing of S304, in which processing to be described below is performed.

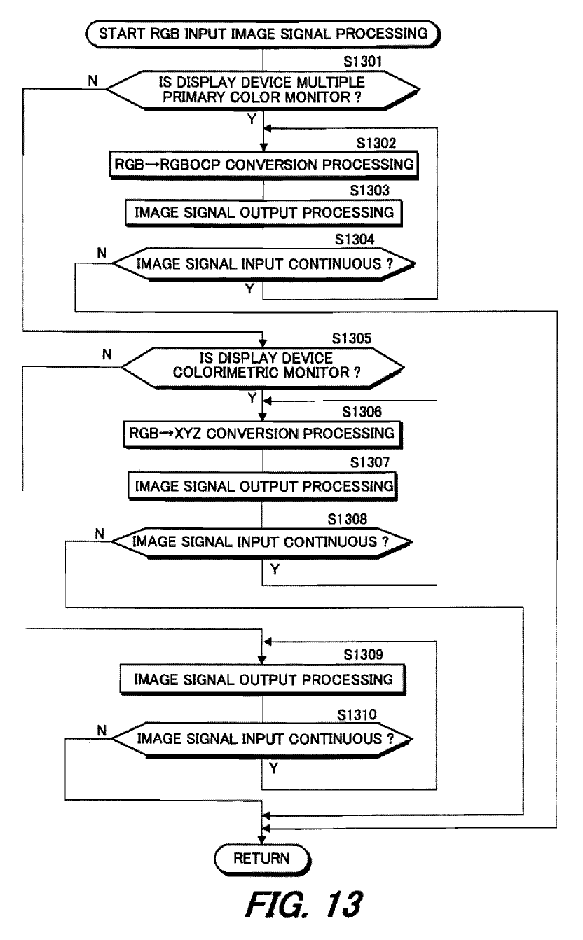

In S304, the color conversion processing device 100 determines whether or not the input image signal is a colorimetric image signal. When the determination is affirmative, the process bifurcates to the processing of S307, in which colorimetric input image signal processing shown in FIGS. 10 to 12 is executed. The process then returns to S301. The determination of S304 is affirmative when the input image signal is a 3-band image signal and includes information for estimating the colorimetry of the photographed subject and so on. When the determination of S304 is negative, the color conversion processing device 100 bifurcates to the processing of S308, in which RGB input image signal processing shown in FIG. 13 is executed. The process then returns to S301.

[Spectral Input Image Signal Processing Procedure]

Referring to the flowcharts in FIGS. 4 to 6, a spectral input image signal processing procedure executed by the color conversion processing device 100 will be described.

In S401, the color conversion processing device 100 determines whether or not the connected monitor display device 140 is a multiple primary color monitor display device, and when the determination is affirmative, the process advances to S402. When the determination is negative, on the other hand, the process advances to S501. The determination of S401 may be made on the basis of the monitor characteristic information.

In S402, the color conversion processing device 100 performs color conversion processing on the basis of the input image signal to realize spectral approximation reproduction display, and then performs prediction processing in S403 for predicting whether or not the obtained display image signal is likely to cause noise. In S404, the color conversion processing device 100 determines whether or not the display image signal is likely to cause noise on the basis of a prediction processing result obtained in S403.

When the determination of S404 is negative, the color conversion processing device 100 bifurcates to the processing of S409, and when the determination of S404 is affirmative, the process advances to S405 to perform colorimetry conversion processing. In other words, when it is determined from the combination of the type of the input image signal and the connected monitor display device that spectral approximation reproduction display is possible but that noise may occur as a result of the spectral approximation reproduction display, the color conversion processing device 100 attempts colorimetric color display, which is the display format positioned one step downward in the order of precedence.

In S406, the color conversion processing device 100 performs prediction processing for predicting whether or not the obtained colorimetric display image signal is likely to cause noise, and in the following S407 determines whether or not the display image signal is likely to cause noise. When the determination of S407 is negative, the color conversion processing device 100 bifurcates to the processing of S411, and when the determination is affirmative, the color conversion processing device 100 advances to S408 to perform RGB value conversion processing. In other words, when the possibility of the noise still remains even after switching the display format from spectral approximation reproduction display to colorimetric color display, the color conversion processing device 100 switches to RGB display, which is the display format positioned a further step downward in the order of precedence.

In S411, which is the bifurcation destination when it is determined in S407 that the possibility of the noise occurring during colorimetric color display does not exist, the color conversion processing device 100 determines whether or not the color difference exceeds a predetermined amount. The color difference is described above, and therefore description here will be kept brief. The color difference is determined on the basis of the chromaticity values of the colorimetry obtained in the processing of S405, and the gamut and display tone (display gamma) that can be displayed by the connected monitor display device 140, and a determination is made as to whether or not the color difference exceeds a predetermined amount. The predetermined amount may be set by the user or determined in accordance with the performance of the color conversion processing device 100 or the monitor display device 140 connected to the color conversion processing device 100.

When the color difference exceeds the predetermined amount and thus an affirmative determination is made in S411, the processing of the color conversion processing device 100 advances to S408, where RGB value conversion processing is performed. When the determination of S411 is negative (the color difference does not exceed the predetermined amount), on the other hand, the color conversion processing device 100 bifurcates to the processing of S409.

In S409, the color conversion processing device 100 performs processing to output the display image signal obtained during the processing of S402, S405, or S408 to the monitor display device 140, and in the following S410, a determination is made as to whether or not image signal input into the color conversion processing device 100 is continuing. When the determination of S410 is affirmative (when it is determined that image signal input is continuing), the color conversion processing device 100 returns to S402 and continues input image signal processing. When the determination of S410 is negative, on the other hand, the color conversion processing device 100 returns to the processing of the main flow shown in FIG. 3.

In S501, which is the bifurcation destination when it is determined in S401 that the monitor display device is not a multiple primary color monitor display device, the color conversion processing device 100 determines whether or not the connected monitor display device 140 is a colorimetric monitor display device. When the determination is negative, the color conversion processing device 100 bifurcates to the processing of S601, and when the determination is affirmative, the color conversion processing device 100 advances to S502 to perform colorimetry conversion processing. In other words, the color conversion processing device 100 attempts colorimetric color display on the basis of the combination of the type of the input image signal and the connected monitor display device.

In S503, the color conversion processing device 100 performs prediction processing for predicting whether or not the colorimetric display image signal obtained in S502 is likely to cause noise, and in the following S504 determines whether or not the display image signal is likely to cause noise. When the determination of S504 is negative, the color conversion processing device 100 bifurcates to the processing of S508, and when the determination is affirmative, the color conversion processing device 100 advances to S505 to perform RGB value conversion processing. In other words, when the noise is likely to occur during colorimetric color display, the color conversion processing device 100 switches to RGB display, which is the display format positioned one step downward in the order of precedence.

In S508, which is the bifurcation destination when it is determined in S504 that the possibility of the noise occurring during colorimetric color display does not exist, the color conversion processing device 100 determines whether or not the color difference exceeds a predetermined amount. More specifically, the color difference is determined on the basis of chromaticity values of the colorimetry obtained during the processing of S502 and the gamut and display tone that can be displayed on the connected monitor display device 140, and a determination is made as to whether or not the color difference exceeds the predetermined amount. The predetermined amount may be set by the user or determined in accordance with the performance of the color conversion processing device 100 or the performance of the monitor display device 140 connected to the color conversion processing device 100.

When the color difference exceeds the predetermined amount such that the determination of S508 is affirmative, the color conversion processing device 100 bifurcates to the processing of S505 and performs RGB value conversion processing. When the determination of S508 is negative (the color difference does not exceed the predetermined amount), on the other hand, the color conversion processing device 100 bifurcates to the processing of S506.

In S506, the color conversion processing device 100 performs processing to output the display image signal obtained during the processing of S502 or S505 to the monitor display device 140, and then determines in the following S507 whether or not image signal input into the color conversion processing device 100 is continuous. When the determination of S507 is affirmative (when it is determined that image signal input is continuous), the color conversion processing device 100 returns to S502 and continues input image signal processing. When the determination of S507 is negative, on the other hand, the color conversion processing device 100 returns to the processing of the main flow shown in FIG. 3.

In S601, which is the bifurcation destination when it is determined in S501 that the monitor display device connected to the color conversion processing device 100 is not a colorimetric monitor display device, the color conversion processing device 100 performs RGB value conversion processing. In S602, the color conversion processing device 100 performs processing to output an RGB display image signal obtained during the processing of S601 to the monitor display device 140, and then determines in the following S603 whether or not image signal input into the color conversion processing device 100 is continuous. When the determination of S603 is affirmative (when it is determined that image signal input is continuous), the color conversion processing device 100 returns to S601 and continues input image signal processing. When the determination of S603 is negative, on the other hand, the color conversion processing device 100 returns to the processing of the main flow shown in FIG. 3.

[Multiband Colorimetric Input Image Signal Processing Procedure]

Referring to the flowcharts shown in FIG. 7 to FIG. 9, a multiband colorimetric input image signal processing procedure executed by the color conversion processing device 100 will be described.

In S701, the color conversion processing device 100 determines whether or not the connected monitor display device 140 is a multiple primary color monitor display device. When the determination is affirmative, the process advances to S702, and when the determination is negative, the process advances to S801. Similarly to the determination of S401, the determination of S701 may be made on the basis of the monitor characteristic information.

In S702, the color conversion processing device 100 determines whether or not the user desires pseudo spectral approximation display. When the determination is affirmative, the process advances to S703, and when the determination is negative, the process bifurcates to the processing of S706.

As regards the determination of S702, when the user desires pseudo spectral approximation, s/he may indicate this desire by operating a remote controller or the like in advance, and a flag may be raised (set) in accordance with this operation. In S702, the determination as to whether or not the user desires pseudo spectral approximation display may be made on the basis of whether or not this flag is set.

In S703, the color conversion processing device 100 performs color conversion processing for achieving pseudo spectral approximation display on the basis of the input image signal, and then performs prediction processing in S704 for predicting whether or not the obtained display image signal is likely to cause noise. In S705, the color conversion processing device 100 determines whether or not the display image signal is likely to cause noise on the basis of the prediction processing result obtained in S704.

When the determination of S705 is negative, the color conversion processing device 100 bifurcates to the processing of S710, and when the determination of S705 is affirmative, the color conversion processing device 100 advances to S706. In S706, which is the bifurcation destination when the determination of S702 is negative (the user does not desire pseudo spectral approximation display) or when the determination of S705 is affirmative (noise is likely to be caused when pseudo spectral approximation display is performed), the color conversion processing device 100 performs colorimetry conversion processing. In other words, when pseudo spectral approximation display is possible according to the combination of the type of input image signal and the connected monitor display device but the user does not desire pseudo spectral approximation display or it is determined that noise may be caused when pseudo spectral approximation display is performed, the color conversion processing device 100 attempts colorimetric color display, which is the display format positioned one step downward in the order of precedence.

In S707, the color conversion processing device 100 performs prediction processing for predicting whether or not the colorimetric display image signal obtained from the processing of S706 is likely to cause noise, and then determines in the following S708 whether or not the display image signal is likely to cause noise. When the determination of S708 is negative, the color conversion processing device 100 bifurcates to the processing of S712, and when the determination is affirmative, the color conversion processing device 100 advances to S709 to perform RGB value conversion processing. In other words, when the possibility of the noise still remains even after switching the display format from pseudo spectral approximation display to colorimetric color display, the color conversion processing device 100 switches to RGB display, which is the display format positioned a further step downward in the order of precedence.

In S712, which is the bifurcation destination when it is determined in S708 that the possibility of the noise occurring during colorimetric color display does not exist, the color conversion processing device 100 determines whether or not the color difference exceeds the predetermined amount. More specifically, the color difference is determined on the basis of the chromaticity values of the colorimetry obtained in the processing of S706 and the gamut and display tone that can be displayed on the connected monitor display device 140, and a determination is made as to whether or not the color difference exceeds the predetermined amount. The predetermined amount may be set by the user or determined in accordance with the performance of the color conversion processing device 100 or the performance of the monitor display device 140 connected to the color conversion processing device 100.

When the color difference exceeds the predetermined amount and thus an affirmative determination is made in S712, the color conversion processing device 100 advances to S709, where RGB value conversion processing is performed. When the determination of S712 is negative (the color difference does not exceed the predetermined amount), on the other hand, the color conversion processing device 100 bifurcates to the processing of S710.

In S710, the color conversion processing device 100 performs processing to output the display image signal obtained in S703, S706, or S709 to the monitor display device 140, and in the following S711, a determination is made as to whether or not image signal input into the color conversion processing device 100 is continuous. When the determination of S711 is affirmative (when it is determined that image signal input is continuous), the color conversion processing device 100 returns to S702 and continues input image signal processing. When the determination of S711 is negative, on the other hand, the color conversion processing device 100 returns to the processing of the main flow shown in FIG. 3.

In S801, which is the bifurcation destination when it is determined in S701 that the monitor display device is not a multiple primary color monitor display device, the color conversion processing device 100 determines whether or not the connected monitor display device 140 is a colorimetric monitor display device. When the determination is negative, the color conversion processing device 100 bifurcates to the processing of S901, and when the determination is affirmative, the color conversion processing device 100 advances to S802 to perform colorimetry 6-3 conversion processing. In other words, the color conversion processing device 100 performs processing to determine the XYZ colorimetry by applying a D2C matrix (a 6-3 conversion matrix) added to the multiband colorimetric input image signal.

In S803, the color conversion processing device 100 performs prediction processing for predicting whether or not the XYZ colorimetric display image signal obtained in the processing of S802 is likely to cause noise, and in the following S804 determines whether or not the display image signal is likely to cause noise. When the determination of S804 is negative, the color conversion processing device 100 bifurcates to the processing of S808, and when the determination is affirmative, the color conversion processing device 100 advances to S805 to perform RGB value conversion processing. In other words, when the noise is likely to occur during colorimetric color display, the color conversion processing device 100 switches to RGB display, which is the display format positioned one step downward in the order of precedence.

In S808, which is the bifurcation destination when it is determined in S804 that the possibility of noise occurring during colorimetric color display does not exist, the color conversion processing device 100 determines whether or not the color difference exceeds the predetermined amount. More specifically, the color difference is determined on the basis of chromaticity values of the XYZ colorimetry obtained during the processing of S802 and the gamut and display tone that can be displayed on the connected monitor display device 140, and a determination is made as to whether or not the color difference exceeds the predetermined amount. The predetermined amount may be set by the user or determined in accordance with the performance of the color conversion processing device 100 or the performance of the monitor display device 140 connected to the color conversion processing device 100.

When the color difference exceeds the predetermined amount and thus the determination of S808 is affirmative, the color conversion processing device 100 bifurcates to the processing of S805 and performs RGB value conversion processing. When the determination of S808 is negative (the color difference does not exceed the predetermined amount), on the other hand, the color conversion processing device 100 bifurcates to the processing of S806.

In S806, the color conversion processing device 100 performs processing to output the display image signal obtained during the processing of S802 or S805 to the monitor display device 140, and then determines in the following S807 whether or not image signal input into the color conversion processing device 100 is continuous. When the determination of S807 is affirmative (when it is determined that image signal input is continuous), the color conversion processing device 100 returns to S802 and continues input image signal processing. When the determination of S807 is negative, on the other hand, the color conversion processing device 100 returns to the processing of the main flow shown in FIG. 3.

In S901, which is the bifurcation destination when it is determined in S801 that the monitor display device connected to the color conversion processing device 100 is not a colorimetric monitor display device, the color conversion processing device 100 performs RGB value conversion processing. In S902, the color conversion processing device 100 performs processing to output an RGB display image signal obtained during the processing of S901 to the monitor display device 140, and then determines in the following S903 whether or not image signal input into the color conversion processing device 100 is continuous. When the determination of S903 is affirmative (when it is determined that image signal input is continuous), the color conversion processing device 100 returns to S901 and continues input image signal processing. When the determination of S903 is negative, on the other hand, the color conversion processing device 100 returns to the processing of the main flow shown in FIG. 3.

[Colorimetric Input Image Signal Processing Procedure]

Referring to the flowcharts in FIG. 10 to FIG. 12, a colorimetric input image signal processing procedure executed by the color conversion processing device 100 will be described.

In S1001, the color conversion processing device 100 determines whether or not the connected monitor display device 140 is a multiple primary color monitor display device. When the determination is affirmative, the process advances to S1002, and when the determination is negative, the process advances to S1101. Similarly to the determination of S401, the determination of S1001 may be made on the basis of the monitor characteristic information.

In S1002, the color conversion processing device 100 determines whether or not the user desires pseudo spectral approximation display. When the determination is affirmative, the process advances to S1003, and when the determination is negative, the process bifurcates to the processing of S1006. As regards the determination of S1002, when the user desires pseudo spectral approximation, s/he may indicate this desire by operating a remote controller or the like in advance, and a flag may be raised (set) in accordance with this operation. In S1002, the determination as to whether or not the user desires pseudo spectral approximation display may be made on the basis of whether or not this flag is set.

In S1003, the color conversion processing device 100 performs color conversion processing for achieving pseudo spectral approximation display on the basis of the input image signal, and then performs prediction processing in S1004 for predicting whether or not the obtained display image signal is likely to cause noise. In S1005, the color conversion processing device 100 determines whether or not the display image signal is likely to cause noise on the basis of the prediction processing result obtained in S1004.

When the determination of S1005 is negative, the color conversion processing device 100 bifurcates to the processing of S1010, and when the determination of S1005 is affirmative, the color conversion processing device 100 advances to S1006. In S1006, which is the bifurcation destination when the determination of S1002 is negative (the user does not desire pseudo spectral approximation display) or when the determination of S1005 is affirmative (noise is likely to be caused when pseudo spectral approximation display is performed), the color conversion processing device 100 performs 3-6 conversion processing on the XYZ colorimetric image signal. In other words, when pseudo spectral approximation display is possible according to the combination of the type of input image signal and the connected monitor display device but the user does not desire pseudo spectral approximation display or it is determined that noise may be caused when pseudo spectral approximation display is performed, the color conversion processing device 100 attempts colorimetric color display, which is the display format positioned one step downward in the order of precedence. To describe the 3-6 conversion processing performed on the XYZ colorimetric image signal, the processing shown in FIG. 10 to FIG. 12 is performed when the input image signal is an XYZ colorimetric image signal, and the processing of S1006 is performed when the image display device is a multiple primary color monitor display device. Hence, in S1006, processing having the content described above in (3-a-5) is performed.

In S1007, the color conversion processing device 100 performs prediction processing for predicting whether or not the colorimetric display image signal obtained from the processing of S1006 is likely to cause noise, and then determines in the following S1008 whether or not the display image signal is likely to cause noise. When the determination of S1008 is negative, the color conversion processing device 100 bifurcates to the processing of S1012, and when the determination is affirmative, the color conversion processing device 100 advances to S1009 to perform RGB value conversion processing. In other words, when the possibility of the noise still remains even after switching the display format from pseudo spectral approximation display to colorimetric color display, the color conversion processing device 100 switches to RGB display, which is the display format positioned a further step downward in the order of precedence.

In S1012, which is the bifurcation destination when it is determined in S1008 that the possibility of the noise occurring during colorimetric color display does not exist, the color conversion processing device 100 determines whether or not the color difference exceeds the predetermined amount. More specifically, the color difference is determined on the basis of the chromaticity values of the 6-primary color colorimetry obtained in the processing of S1006 and the gamut and display tone that can be displayed on the connected monitor display device 140, and a determination is made as to whether or not the color difference exceeds a predetermined amount. The predetermined amount may be set by the user or determined in accordance with the performance of the color conversion processing device 100 or the performance of the monitor display device 140 connected to the color conversion processing device 100.

When the color difference exceeds the predetermined amount such that an affirmative determination is made in S1012, the color conversion processing device 100 advances to S1009, where RGB value conversion processing is performed. When the determination of S1012 is negative (the color difference does not exceed the predetermined amount), on the other hand, the color conversion processing device 100 bifurcates to the processing of S1010.

In S1010, the color conversion processing device 100 performs processing to output the display image signal obtained in S1003, S1006, or S1009 to the monitor display device 140, and in the following S1011, a determination is made as to whether or not image signal input into the color conversion processing device 100 is continuous. When the determination of S1011 is affirmative (when it is determined that image signal input is continuous), the color conversion processing device 100 returns to S1002 and continues input image signal processing. When the determination of S1011 is negative, on the other hand, the color conversion processing device 100 returns to the processing of the main flow shown in FIG. 3.

In S1101, which is the bifurcation destination when it is determined in S1001 that the monitor display device is not a multiple primary color monitor display device, the color conversion processing device 100 determines whether or not the connected monitor display device 140 is a colorimetric monitor display device. When the determination is negative, the color conversion processing device 100 bifurcates to the processing of S1201, and when the determination is affirmative, the color conversion processing device 100 advances to S1102. In S1102, the color conversion processing device 100 performs prediction processing for predicting whether or not the colorimetric display image signal is likely to cause noise. It should be noted that color conversion processing is not performed between the processing of S1101 and the processing of S1102, and the reason for this is that the monitor display device 140 is a colorimetric monitor display device, and therefore the monitor display device 140 performs processing to correct the monitor display characteristic itself.

In S1103, the color conversion processing device 100 determines whether or not the display image signal is likely to cause noise on the basis of the prediction result regarding the possibility of the noise during colorimetric color display, obtained in S1102. When the determination of S1103 is negative, the color conversion processing device 100 bifurcates to the processing of S1107, and when the determination is affirmative, the color conversion processing device 100 advances to S1104 to perform RGB value conversion processing. In other words, when the noise is likely to occur during colorimetric color display, the color conversion processing device 100 switches to RGB display, which is the display format positioned one step downward in the order of precedence.

In S1107, which is the bifurcation destination when it is determined in S1103 that the possibility of noise occurring during colorimetric color display does not exist, the color conversion processing device 100 determines whether or not the color difference exceeds the predetermined amount. More specifically, the color difference is determined on the basis of chromaticity values based on input XYZ colorimetry and the gamut and display tone that can be displayed on the connected monitor display device 140, and a determination is made as to whether or not the color difference exceeds the predetermined amount. The predetermined amount may be set by the user or determined in accordance with the performance of the color conversion processing device 100 or the performance of the monitor display device 140 connected to the color conversion processing device 100.

When the color difference exceeds the predetermined amount and thus the determination of S1107 is affirmative, the color conversion processing device 100 bifurcates to the processing of S1104 and performs RGB value conversion processing. When the determination of S1107 is negative (the color difference does not exceed the predetermined amount), on the other hand, the color conversion processing device 100 bifurcates to the processing of S1105.

In S1105, the color conversion processing device 100 performs processing to output an XYZ colorimetric input image signal or the display image signal obtained during the processing of S1104 to the monitor display device 140, and then determines in the following S1106 whether or not image signal input into the color conversion processing device 100 is continuous. When the determination of S1106 is affirmative (when it is determined that image signal input is continuous), the color conversion processing device 100 returns to S1102 and continues input image signal processing. When the determination of S1106 is negative, on the other hand, the color conversion processing device 100 returns to the processing of the main flow shown in FIG. 3.

In S1201, which is the bifurcation destination when it is determined in S1101 that the monitor display device connected to the color conversion processing device 100 is not a colorimetric monitor display device, the color conversion processing device 100 performs RGB value conversion processing. In S1202, the color conversion processing device 100 performs processing to output an RGB display image signal obtained during the processing of S1201 to the monitor display device 140, and then determines in the following S1203 whether or not image signal input into the color conversion processing device 100 is continuous. When the determination of S1203 is affirmative (when it is determined that image signal input is continuous), the color conversion processing device 100 returns to S1201 and continues input image signal processing. When the determination of S1203 is negative, on the other hand, the color conversion processing device 100 returns to the processing of the main flow shown in FIG. 3.

[RGB Input Image Signal Processing Procedure]

Referring to the flowchart shown in FIG. 13, an RGB input image signal processing procedure executed by the color conversion processing device 100 will be described.

In S1301, the color conversion processing device 100 determines whether or not the connected monitor display device 140 is a multiple primary color monitor display device. When the determination is affirmative, the process advances to S1302, and when the determination is negative, the process advances to S1305. Similarly to the determination of S401, the determination of S1301 may be made on the basis of the monitor characteristic information.

In S1302, the color conversion processing device 100 performs processing to convert the RGB input image signal into an RGBOCP signal corresponding to the primary colors of the connected monitor display device 140. The method described above in (3-a-7) may be applied to this processing.

In S1303, the color conversion processing device 100 performs processing to output the display image signal obtained in the processing of S1302 to the monitor display device 140, and then determines in the following S1304 whether or not image signal input into the color conversion processing device 100 is continuous. When the determination of S1304 is affirmative (when it is determined that image signal input is continuous), the color conversion processing device 100 returns to S1302 and continues input image signal processing. When the determination of S1304 is negative, on the other hand, the color conversion processing device 100 returns to the processing of the main flow shown in FIG. 3.

In S1305, which is the bifurcation destination when it is determined in S1301 that the monitor display device is not a colorimetric monitor display device, the color conversion processing device 100 determines whether or not the connected monitor display device 140 is a colorimetric monitor display device. When this determination is negative, the color conversion processing device 100 bifurcates to the processing of S1309, and when the determination is affirmative, the color conversion processing device 100 advances to S1306. In S1306, the color conversion processing device 100 performs processing to convert the RGB image signal into an XYZ signal. The processing method employed here is as described above in (3-b-4). Further, as described in (3-b-4), the XYZ signal caused in the processing of S1306 is not colorimetric.

In S1307, the color conversion processing device 100 performs processing to output the display image signal (XYZ signal) obtained during the processing of S1306 to the monitor display device 140, and then determines in the following S1308 whether or not image signal input into the color conversion processing device 100 is continuous. When the determination of S1308 is affirmative (when it is determined that image signal input is continuous), the color conversion processing device 100 returns to S1306 and continues input image signal processing. When the determination of S1308 is negative, on the other hand, the color conversion processing device 100 returns to the processing of the main flow shown in FIG. 3.

In S1309, which is the bifurcation destination when it is determined in S1305 that the monitor display device connected to the color conversion processing device 100 is not a colorimetric monitor display device, the color conversion processing device 100 performs processing to output the RGB display image signal to the monitor display device 140, and then determines in the following S1310 whether or not image signal input into the color conversion processing device 100 is continuous. When the determination of S1310 is affirmative (when it is determined that image signal input is continuous), the color conversion processing device 100 returns to S1309 and continues input image signal processing. When the determination of S1310 is negative, on the other hand, the color conversion processing device 100 returns to the processing of the main flow shown in FIG. 3.

As described above with reference to the flowcharts shown in FIGS. 3 to 13, the color conversion processing device 100 selects the display method automatically on the basis of the type of input image signal and the display performance of the connected monitor display device 140. At this time, spectral approximation display, pseudo spectral approximation display based on multiband colorimetry, pseudo spectral approximation display based on XYZ colorimetry, colorimetric color display based on multiband colorimetry, colorimetric color display based on XYZ colorimetry, and RGB display are set in that order as an order of precedence, and display process is performed after selecting the display method having the highest order of precedence (highest quality) from among the selectable display methods. When the noise is predicted during an attempt to perform display using the display method having the highest order of precedence, an attempt is made to perform display using the display method positioned one step downward in the order of precedence. When the noise is still predicted, an attempt is made to perform display using the display method positioned a further step downward in the order of precedence. When the noise continues to be predicted, display is finally performed using the RGB display method.

Thus, the color conversion processing device 100 according to this embodiment of the invention determines the type of the input image signal, the display performance of the connected monitor display device 140, and the possibility of the noise, and performs display after automatically selecting the preferred display method from among the possible display methods. As a result, the user does not have to perform troublesome display method switching operations, and images can be viewed easily using the optimum display method.

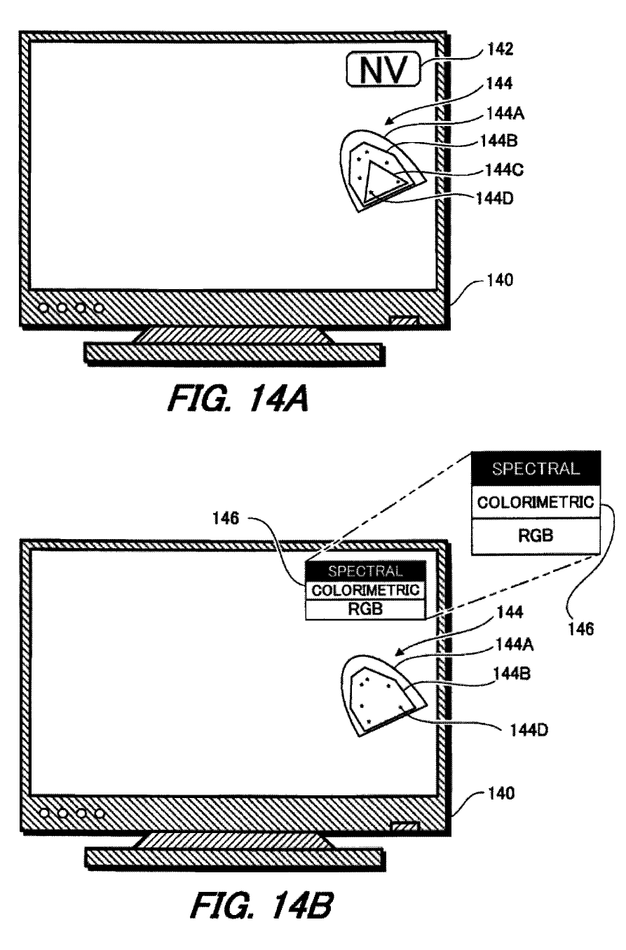

FIG. 14 shows examples of icons superimposed onto the monitor display device 140 connected to the color conversion processing device 100. FIG. 14A shows an example in which the monitor display device 140 is an RGB monitor display device, and FIG. 14B shows an example in which the monitor display device 140 is a multiple primary color monitor display device. Image signals for displaying these icons are caused in the color conversion processing device 100, superimposed onto the display image signal caused through input image signal processing, and output to the monitor display device 140. The image signals for displaying these icons may be caused by the color conversion processing execution unit 114, and may be displayed in an upper right region on the display surface of the monitor display device 140, for example.

When an RGB monitor display device is connected to the color conversion processing device 100, only RGB display is performed on the monitor display device 140, regardless of the type of the input image signal, as described above with reference to the flowcharts shown in FIGS. 3 to 13. At this time, an input signal icon 142 and a gamut icon 144 are displayed on the display screen of the monitor display device 140, as shown in the example of FIG. 14A. The gamut icon 144 includes a visible range gamut icon 144A, an input image signal gamut icon 144B, a monitor gamut icon 144C, an input signal chromaticity point indicator icon 144D, and so on.

The input signal icon 142 is used to display the type of the image signal input into the color conversion processing device 100, and by viewing the icon, the user can determine the type of the current input image signal intuitively. The input signal icon 142 shown in the example of FIG. 14A indicates that the input image signal is a spectral image signal (a natural vision image signal).

The visible range gamut icon 144A is an icon representing a gamut corresponding to the visible range of the human eye (a CIE standard observer). The input image signal gamut icon 144B is an icon indicating the magnitude of the gamut of an image based on the input image signal. The input image signal gamut icon 144B may be displayed as a polygon obtained by linking chromaticity points positioned on the outermost sides (in the widest range) when chromaticity points defined by image signals input within a fixed time interval are plotted on a sequential chromaticity graph. In other words, the polygon represents a gamut encompassing a collection of chromaticity points defined by the input image signals input within a fixed time interval. By refreshing (updating) the display of the input image signal gamut icon 144B at appropriate time intervals, so-called peak hold display of the gamut of the most recent input image signals is performed. For example, when an image signal including high-chroma colors of various wavelengths, such as an image of tropical birds, flowers and so on, is input, the input image signal gamut icon 144 is displayed as a polygon having a larger area. On the other hand, when a signal of an image having a smaller gamut, such as a snow scene or a dark image, is input, the input image signal gamut icon 144B is displayed as a polygon having a smaller area or a point.

The monitor gamut icon 144C is an icon representing the gamut of the colors that can be displayed on the monitor display device 140 connected to the color conversion processing device 100, and similarly to the visible range gamut icon 144A, this icon is displayed fixedly, without varying over time or in accordance with variation in the input image signal. The input signal chromaticity point indicator icon 144D is used to display the chromaticity points represented by the input image signal. The input signal chromaticity point indicator icon 144D is updated at shorter time intervals than the display update time interval of the input image signal gamut icon 144B. When the input signal chromaticity point indicator icon 144D is displayed inside the monitor gamut icon 144C, the user can confirm that the gamut defined by the input image signal is within the gamut of the colors that can be displayed by the monitor display device 140. In other words, the user can confirm that an image signal contained within the display capacity range of the monitor display device 140 has been input for display. This applies likewise to a case in which the input image signal gamut icon 144B is displayed inside the monitor gamut icon 144C.

When the user experiences a sense of discomfort upon viewing the colors of an image displayed on the monitor display device 140, s/he can determine whether this is due to poor adjustment of the monitor display device 140 or input of an image signal having a gamut that exceeds the display capacity of the monitor display device 140 by viewing the gamut icon 144.

When the monitor display device 140 connected to the color conversion processing device 100 is a multiple primary color monitor display device, a display mode icon 146 and the gamut icon 144 are displayed, as shown in the example of FIG. 14B. In the example shown in FIG. 14B, the gamut icon 144 includes the visible range gamut icon 144A, the input image signal gamut icon 144B, the input signal chromaticity point indicator icon 144D, and so on.

The display mode icon 146 is used to indicate the type of color conversion processing performed in the monitor display device 140. In the example shown in FIG. 14B, the alphabetic characters “spectral” having higher lightness are displayed on a background having lower lightness, and therefore the user can learn that the display image signal has been output following color conversion processing for achieving spectral reproduction display. Further, by viewing the input image signal gamut icon 144B and the input signal chromaticity point indicator icon 144D, the user can confirm that display utilizing the wider gamut of the monitor display device 140 is underway.

When icons such as those shown in FIG. 14B are displayed, the user can learn that spectral reproduction display is underway. As a result, a further effect can be obtained. Specifically, when spectral reproduction display is underway, images suppressing observer metamerism can be displayed and display that is unlikely to be affected by individual differences in the color matching function can be performed. When a presentation is performed while acknowledging that spectral reproduction display is underway and a large number of participants observe two colors displayed on the monitor display device 140, for example, a presenter can give an explanation that, “one color is slightly redder than the other color”. When spectral reproduction display is not underway, on the other hand, the tint of the displayed colors may differ according to the participant. Therefore, when it is possible to confirm that spectral reproduction display is not underway by viewing the display mode icon 146 and gamut icon 144, the participants can determine that discussions regarding slight differences in the tint of the displayed image are to be avoided.

[Noise Occurring Prediction Prior to Color Conversion Processing]

In the examples described above with reference to FIGS. 3 to 13, noise determination is performed after color conversion processing, and when the noise is predicted, different color conversion (having the next highest order of precedence) is applied. However, this invention is not limited to this example, and when the noise determination is possible prior to color conversion processing, noise determination may be performed first such that color conversion processing is performed using a color conversion method selected on the basis of the determination result.

As described above, when a color having a certain spectral distribution is reproduced using multiple primary colors, noise may become evident depending on the relationship between the spectral distribution of each primary color of the monitor display device and the spectral distribution of the color to be reproduced. It is usually impossible to know whether or not the color to be reproduced by the monitor display device has a spectral distribution from which noise may be caused until color conversion is actually performed. In certain cases, however, it is possible to predict noise in advance on the basis of the D2R information and observing illuminant information or on the basis of the D2S information. In such cases, noise prediction can be performed before color conversion processing.

When a color is reproduced using the colorimetry values, noise may occur (become evident) depending on the relationship between the spectral distribution of each primary color of the monitor display device, or the colorimetry representing the respective primary colors of the monitor display device, and the colorimetry of the color to be reproduced, but in certain cases, noise can be predicted in advance on the basis of the D2C information. In such cases, noise prediction can be performed before color conversion processing.

When the noise can be predicted before color conversion processing, as in the cases described above, the load required for the color conversion processing is reduced, and the processing time is shortened. This is suitable for a case in which successive color conversion processing is implemented on an input image signal of a video image to be displayed.

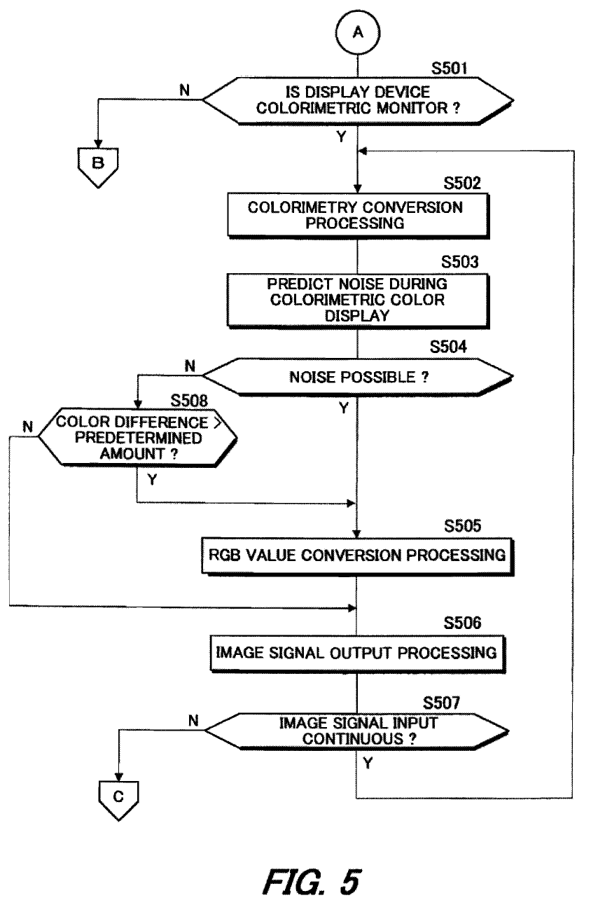

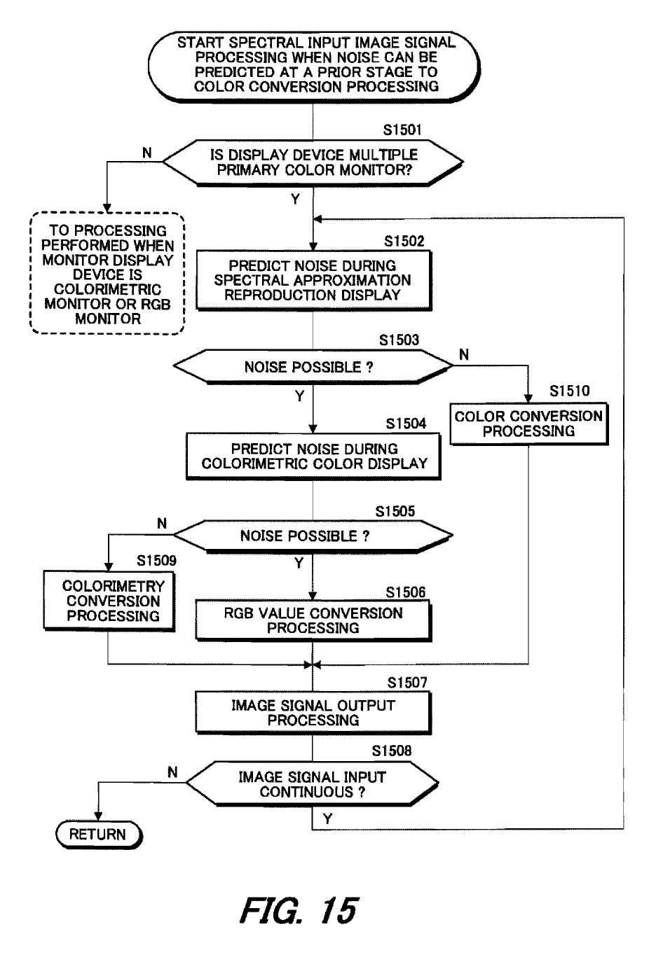

FIG. 15 is a flowchart showing an example in which the processing shown in FIG. 4 is modified such that noise is predicted at a prior stage to color conversion processing. A similar modification may be applied to FIGS. 5, 7, 8, 10 and 11, but to reduce the description length, only the example in which the processing of FIG. 4 is modified will be described here.

Similarly to the other flowcharts, the processing of the flowchart shown in FIG. 15 is executed by the color conversion processing device 100. FIG. 15 shows a spectral input image signal processing procedure that is accessed when it is determined in the determination processing of S302 in FIG. 3 that the type of the input image signal is a spectral image signal.

In S1501, the color conversion processing device 100 determines whether or not the connected monitor display device 140 is a multiple primary color monitor. When the determination is affirmative, the process advances to S1502, and when the determination is negative, the process bifurcates to the processing (indicated by a broken line in FIG. 15) that is performed when the monitor display device 140 is a colorimetric monitor display device or an RGB monitor display device.

In S1502, the color conversion processing device 100 performs prediction processing on the basis of the D2R information included in the input image signal and information relating to the observing illuminant spectrum, which is input from the illumination characteristic input unit 116, to predict whether or not noise is likely to occur upon spectral display. In S1503, the color conversion processing device 100 determines on the basis of a prediction processing result obtained in S1502 whether or not noise occurring is possible in the display image signal upon spectral display.

When the determination of S1503 is negative, the color conversion processing device 100 bifurcates to the processing of S1510 to perform color conversion processing for spectral display. When the determination is affirmative, on the other hand, the color conversion processing device 100 advances to S1504 to perform processing for predicting noise during colorimetric color display. To describe the processing performed in S1504 for predicting noise during colorimetric color display, the color conversion processing device 100 performs prediction processing on the basis of the D2C information to predict whether or not noise occurring is likely to happen in the display image signal upon colorimetric color display. The D2C information may be prepared in advance in the interior of the color conversion processing device 100 prior to the start of image display, during intervals between scenes, or similar on the basis of the D2R information included in the input spectral image signal and the information relating to the observing illuminant spectrum, input from the illumination characteristic input unit 116.

In S1505, the color conversion processing device 100 determines whether or not noise occurring is possible in the display image signal upon colorimetric color display on the basis of the result obtained in S1504 during the processing for predicting noise during colorimetric color display. When the determination of S1505 is negative, the color conversion processing device 100 bifurcates to the processing of S1509 to perform processing to convert the input image signal into a colorimetric image signal, and when the determination is affirmative, the color conversion processing device 100 advances to S1506 to perform RGB value conversion processing.

In S1507, the color conversion processing device 100 performs processing to output the display image signal obtained during the processing of S1509, S1510 or S1506 to the monitor display device 140, and then determines in the following S1508 whether or not image signal input into the color conversion processing device 100 is continuous. When the determination of S1508 is affirmative (when it is determined that image signal input is continuous), the color conversion processing device 100 returns to S1502 and continues input image signal processing, and when the determination of S1508 is negative, the color conversion processing device 100 returns to the processing of the main flow shown in FIG. 3.

The color conversion processing device 100 described above may be constituted independently of the monitor display device 140 or incorporated into the interior of the monitor display device 140. In this case, the type of the monitor display device is fixed at a single type, and therefore the color conversion processing device 100 varies the display format in accordance with the type of the input image signal. The color conversion processing device 100 may also be incorporated into an optical disk player or the like. In this case, image characteristic information and the like included in an image signal read from the optical disk during reproduction is input, whereupon the color conversion processing described above is performed.

The image display technique according to this invention may be used in an image display system employing an image projection device such as a television receiver, a video monitor display device, a computer monitor display device, or a data projector, and so on.

Additional advantages and modifications will readily occur t those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

The entire contents of Japanese Patent Application JP2007-264792 (filed on Oct. 10, 2007) is incorporated herein by reference.

What is claimed is:

1. An image signal processing device comprising:
a color conversion processing portion for implementing color conversion processing on an input image signal and outputting a color conversion-processed display image signal to an image display unit;
a color conversion characteristic information input portion that inputs color conversion characteristic information required for the color conversion processing; and
a color conversion processing method selection portion that selects an optimum color conversion processing method, from among a plurality of candidate color conversion processing methods that can be executed by the color conversion processing portion, on the basis of the input image signal and the input color conversion characteristic information.

2. The image signal processing device as defined in claim 1, wherein the color conversion characteristic information input portion further comprises:
an image characteristic information input portion that inputs image characteristic information included in the input image signal; and
a display characteristic information input portion that inputs display characteristic information of the image display unit,
wherein the color conversion processing method selection portion is constituted to be capable of selecting the optimum color conversion processing method on the basis of the color conversion characteristic information including the image characteristic information and the display characteristic information.

3. The image signal processing device as defined in claim 2, wherein the color conversion characteristic information input portion further comprises an observing illuminant characteristic input portion that inputs a characteristic of an observing illuminant, which is an illuminant of an environment surrounding an observer observing an image displayed on the image display unit and the image display unit, and
the observing illuminant characteristic input portion comprises at least one of:
an illuminant characteristic information input portion into which illuminant characteristic information relating to the characteristic of the observing illuminant can be input by the observer; and
an observing illuminant characteristic measurement portion capable of generating the illuminant characteristic information by measuring the characteristic of the observing illuminant.

4. The image signal processing device as defined in claim 3, wherein the color conversion processing method selection portion is constituted to be capable of determining a quality of a display image, that is reproduced by the image display unit based on the display image signal generated by the color conversion processing, on the basis of a noise or a color difference occurring in the reproduced display image, and selecting a color conversion method with which the noise or the color difference is reduced from among the plurality of color conversion methods on the basis of a determination result regarding the quality of the display image.

5. The image signal processing device as defined in claim 1, wherein an image signal for displaying information relating to at least one of a type of the input image signal and the color conversion processing method to be executed by the color conversion processing portion on the image display unit can be output to the image display unit.

6. The image signal processing device as defined in claim 5, wherein an image signal for displaying a pattern that represents a gamut encompassing a collection of chromaticity points defined by input image signals input within a fixed time interval on the image display unit while updating the pattern at fixed time intervals can be output to the image display unit.

7. The image signal processing device as defined in claim 5, wherein an image signal for displaying a pattern that represents chromaticity points defined by an input image signal on the image display unit while updating the pattern at fixed time intervals can be output to the image display unit.

8. The image signal processing device as defined in claim 4, wherein the color conversion processing method selection portion selects, in accordance with a predetermined order of precedence, a color conversion method having the highest order of precedence from among the plurality of color applicable candidate conversion methods on the basis of the image characteristic information, the display characteristic information, the illuminant characteristic information, and the quality of the display image.

9. A color conversion processing method for implementing color conversion processing on an input image signal and outputting a color conversion-processed display image signal to an image display unit, comprising:
inputting color conversion characteristic information used for the color conversion processing, the color conversion characteristic information including display characteristic information relating to the image display unit and image characteristic information included in the input image signal; and
selecting a color conversion processing method, which means selecting, in accordance with a predetermined order of precedence, a color conversion method having the highest order of precedence from among a plurality of applicable candidate color conversion methods on the basis of the input color conversion characteristic information.

10. The color conversion processing method as defined in claim 9, wherein inputting the color conversion characteristic information further comprises inputting an illumination characteristic of an observing illuminant, which is an illuminant of an environment surrounding an observer observing an image displayed on the image display unit and the image display unit.

11. The color conversion processing method as defined in claim 10, further comprising determining a quality of a display image, that is reproduced by the image display unit based on the display image signal generated by the color conversion processing, on the basis of a noise or a color difference occurring in the reproduced display image,
wherein the selecting a color conversion processing method further comprises selecting a color conversion method with which the noise or the color difference is reduced, by taking into account a determination result regarding the quality of the display image while selecting, in accordance with the predetermined order of precedence, the color conversion method having the highest order of precedence from among the plurality of applicable candidate color conversion methods.

12. The color conversion processing method as defined in claim 11, further comprising outputting to the image display unit an image signal for displaying information, relating to at least one of a type of the input image signal and the color conversion processing method executed by the color conversion processing portion, on the image display unit.

13. The color conversion processing method as defined in claim 12, further comprising outputting to the image display unit an image signal for displaying a pattern that represents a gamut encompassing a collection of chromaticity points defined by input image signals input within a fixed time interval on the image display unit while updating the pattern at fixed time intervals.

14. The color conversion processing method as defined in claim 13, further comprising outputting to the image display unit an image signal for displaying a pattern that represents a chromaticity points defined by an input image signal on the image display unit while updating the pattern at fixed time intervals.
